(19) United States
(12) Patent Application Publication
(10) Pub. No.: US 2020/0285135 A1
(43) Pub. Date: Sep. 10, 2020

(54) Lens Apparatus

(71) Applicants: Sintai Optical (Shenzhen) Co., Ltd., ShenZhen City (CN); Asia Optical Co., Inc., Taichung (TW)

(72) Inventor: Chia-Hung Sun, Taichung (TW)

(21) Appl. No.: 16/798,793

(22) Filed: Feb. 24, 2020

(30) Foreign Application Priority Data
Mar. 7, 2019 (CN) 201910171477.9

(51) Int. Cl. G03B 21/14; G02B 13/18; G02B 15/14

(52) U.S. Cl. CPC G03B 21/147; G02B 15/144515; G02B 13/18

(57) ABSTRACT

A lens apparatus includes a first lens group, a second lens group, a third lens group and a fourth lens group. The first lens group includes a first lens with negative refractive power and a second lens with negative refractive power. The second lens group includes a third lens with positive refractive power. The third lens group includes a fourth lens with positive refractive power. The fourth lens group includes a fifth lens with negative refractive power, a sixth lens with positive refractive power and a seventh lens with positive refractive power. The lens apparatus satisfies: −2.28<f_{LG1}/f<−0.59, where f is an effective focal length of the lens apparatus, and f_{LG1} is an effective focal length of the first lens group.

### BACKGROUND OF THE INVENTION

### Field of the Invention

The invention relates to a lens apparatus.

### Description of the Related Art

The current development trend of a projector is toward high brightness and high resolution. Additionally, the projector is developed to have zoom capability in accordance with different application requirements, so that a lens apparatus therein is developed to have large aperture, high resolution and zoom capability. However, the known lens apparatus can't satisfy such requirements. Therefore, a lens apparatus needs a new structure in order to meet the requirements of large aperture, high resolution and zoom capability at the same time.

### BRIEF SUMMARY OF THE INVENTION

The invention provides a lens apparatus to solve the above problems. The lens apparatus of the invention is provided with characteristics of a decreased F-number, an increased resolution, and a capability to zoom, and still has a good optical performance.

The lens apparatus in accordance with the invention includes a first lens group, a second lens group, a third lens group and a fourth lens group. The first lens group includes a first lens with negative refractive power and a second lens with negative refractive power, wherein the first lens includes a convex surface facing an image side and a concave surface facing an objective side. The second lens group includes a third lens with positive refractive power. The third lens group includes a fourth lens with positive refractive power. The fourth lens group includes a fifth lens with negative refractive power, a sixth lens with positive refractive power and a seventh lens with positive refractive power, wherein the seventh lens includes a convex surface facing the image side. The first lens, the second lens, the third lens, the fourth lens, the fifth lens, the sixth lens and the seventh lens are arranged in order from the image side to the objective side along an optical axis. The lens apparatus satisfies: −2.28<f_{LG1}/f<−0.59, where f is an effective focal length of the lens apparatus, and f_{LG1} is an effective focal length of the first lens group.

In another embodiment, the second lens includes a concave surface facing the objective side, the fourth lens includes a convex surface facing the image side, the fifth lens includes a concave surface facing the image side, the sixth lens includes a convex surface facing the image side, and the seventh lens includes a convex surface facing the objective side.

In yet another embodiment, the second lens includes a convex surface or a concave surface facing the image side, the third lens includes a convex surface or a concave surface facing the image side, the fourth lens includes a convex surface or a flat surface facing the objective side, the fifth lens includes a concave surface or a flat surface facing the objective side, and the sixth lens includes a convex surface or a flat surface facing the objective side.

In another embodiment, the first lens group is with negative refractive power and the fourth lens group is with positive refractive power.

In yet another embodiment, the second lens comprises a convex surface or a concave surface facing the image side; the third lens comprises a convex surface or a concave surface facing the image side; the fourth lens comprises a convex surface or a flat surface facing the objective side; the fifth lens comprises a concave surface or a flat surface facing the objective side; and the sixth lens comprises a convex surface or a flat surface facing the objective side.

In another embodiment, the first lens group further comprises an eighth lens disposed between the image side and the first lens, and the eighth lens is with positive refractive power and comprises a convex surface facing the image side and a concave surface facing the objective side.

In yet another embodiment, the second lens group is with positive refractive power, and the third lens group is with positive refractive power.

In another embodiment, the second lens comprises a concave surface facing the objective side, and comprises a convex surface or another concave surface facing the image side; the third lens comprises a convex surface or a concave surface facing the image side; the fourth lens comprises a convex surface facing the image side, and comprises another convex surface or a flat surface facing the objective side; the fifth lens comprises a concave surface facing the image side, and comprises another concave surface or a flat surface facing the objective side; the sixth lens comprises a convex surface facing the image side, and comprises another convex surface or a flat surface facing the objective side; and the seventh lens comprises a convex surface facing the objective side.

In yet another embodiment, the first lens group further comprises an eighth lens disposed between the image side and the first lens, and the eighth lens is with positive refractive power and comprises a convex surface facing the image side and a concave surface facing the objective side.

In another embodiment, the lens apparatus satisfies −9.6≤TTL/f_{LG1}≤−5.19, 29 mm<f₁+f₃<90 mm, or 1.77<f₃/f<12 where f_{LG1} is the effective focal length of the first lens group, TTL is a distance between an image side surface of a lens closest to the image side and an objective side surface of the seventh lens along the optical axis, f is the effective focal length of the lens apparatus, f₃ is a focal length of the third lens, and f₁ is a focal length of the first lens.

In yet another embodiment, the lens apparatus satisfies 2≤Vd₆/Vd₃≤4, 8.16 mm<|T_{S1ST}−T_{S3S10}<|22.92 mm, 5.22<T_{S1ST}/T_{STS15}<8.23, or −2.54<T7ob/f_{LG1}<−1.3 where Vd₃ is an Abbe number of the third lens, Vd₆ is an Abbe number of the sixth lens, T_{S1ST} is a distance between an image side surface of a lens closest to the image side and the stop along the optical axis, T_{S3S10} is a distance between an image side surface of the second lens and an image side surface of the fifth lens along the optical axis, T_{STS15} is a distance between the stop and an objective side surface of the seventh lens along the optical axis, f_{LG1} is the effective focal length of the first lens group, and T7ob is a distance between an objective side surface of the seventh lens and an object along the optical axis.

In another embodiment, at least one of the first lens group, the second lens group, the third lens group and the fourth lens group is movable along the optical axis, the fifth lens and the sixth lens are cemented together, and the lens apparatus is a projection lens.

In yet another embodiment, the lens apparatus satisfies 2≤Vd₆/Vd₃≤4, where Vd₃ is an Abbe number of the third lens, and Vd₆ is an Abbe number of the sixth lens.

In another embodiment, the lens apparatus satisfies 29 mm<|f₁+f₃<90 mm; and 1.77<f₃/f<12, where f is the effective focal length of the lens apparatus, f₃ is a focal length of the third lens, and f₁ is a focal length of the first lens.

In yet another embodiment, the lens apparatus satisfies −9.6≤TTL/f_{LG1}≤−5.19, where f_{LG1} is the effective focal length of the first lens group, and TTL is a distance between an image side surface of a lens closest to the image side and an objective side surface of the seventh lens along the optical axis.

In another embodiment, the fourth lens group further comprises a stop disposed between the fourth lens and the fifth lens, and the lens apparatus satisfies 8.16 mm<|T_{S1ST}−T_{S3S10}|<22.92 mm, or 5.22<T_{S1ST} T_{STS15}<8.23, where T_{S1ST} is a distance between an image side surface of a lens closest to the image side and the stop along the optical axis, T_{S3S10} is a distance between an image side surface of the second lens and an image side surface of the fifth lens along the optical axis, and T_{STS15} is a distance between the stop and an objective side surface of the seventh lens along the optical axis.

In yet another embodiment, the lens apparatus satisfies −2.54<T7ob/f_{LG1}<−1.3, where f_{LG1} is the effective focal length of the first lens group, and T7ob is a distance between an objective side surface of the seventh lens and an object along the optical axis.

In another embodiment, at least one of the first lens group, the second lens group, the third lens group and the fourth lens group is movable along the optical axis, the fifth lens and the sixth lens are cemented together, and the lens apparatus is a projection lens.

In yet another embodiment, the lens apparatus satisfies −9.6≤TTL/f_{LG1}−5.19, where f_{LG1} is the effective focal length of the first lens group, and TTL is a distance between an image side surface of a lens closest to the image side and an objective side surface of the seventh lens along the optical axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a lens apparatus in accordance with a first embodiment of the invention at a wide-angle end;

FIG. 2A depicts a field curvature diagram of the lens apparatus of FIG. 1 at the wide-angle end;

FIG. 2B is a distortion diagram of the lens apparatus of FIG. 1 at the wide-angle end;

FIG. 2C is a relative illumination diagram of the lens apparatus of FIG. 1 at the wide-angle end;

FIG. 2D is a modulation transfer function diagram of the lens apparatus of FIG. 1 at the wide-angle end;

FIG. 2E is a modulation transfer function diagram of the lens apparatus of FIG. 1 at a telephoto end;

FIG. 2F is a through focus modulation transfer function diagram of the lens apparatus of FIG. 1 at the wide-angle end;

FIG. 2G is a through focus modulation transfer function diagram of the lens apparatus of FIG. 1 at the telephoto end;

FIG. 3 is a lens layout and optical path diagram of a lens apparatus in accordance with a second embodiment of the invention at a wide-angle end;

FIG. 4A depicts a field curvature diagram of the lens apparatus of FIG. 3 at the wide-angle end;

FIG. 4B is a distortion diagram of the lens apparatus of FIG. 3 at the wide-angle end;

FIG. 4C is a relative illumination diagram of the lens apparatus of FIG. 3 at the wide-angle end;

FIG. 4D is a modulation transfer function diagram of the lens apparatus of FIG. 3 at the wide-angle end;

FIG. 4E is a modulation transfer function diagram of the lens apparatus of FIG. 3 at a telephoto end;

FIG. 4F is a through focus modulation transfer function diagram of the lens apparatus of FIG. 3 at the wide-angle end;

FIG. 4G is a through focus modulation transfer function diagram of the lens apparatus of FIG. 3 at the telephoto end;

FIG. 5 is a lens layout and optical path diagram of a lens apparatus in accordance with a third embodiment of the invention at a wide-angle end;

FIG. 6A depicts a field curvature diagram of the lens apparatus of FIG. 5 at the wide-angle end;

FIG. 6B is a distortion diagram of the lens apparatus of FIG. 5 at the wide-angle end;

FIG. 6C is a relative illumination diagram of the lens apparatus of FIG. 5 at the wide-angle end;

FIG. 6D is a modulation transfer function diagram of the lens apparatus of FIG. 6 at the wide-angle end;

FIG. 6E is a modulation transfer function diagram of the lens apparatus of FIG. 5 at a telephoto end;

FIG. 6F is a through focus modulation transfer function diagram of the lens apparatus of FIG. 5 at the wide-angle end;

FIG. 6G is a through focus modulation transfer function diagram of the lens apparatus of FIG. 5 at the telephoto end;

FIG. 7 is a lens layout and optical path diagram of a lens apparatus in accordance with a fourth embodiment of the invention at a wide-angle end;

FIG. 8A depicts a field curvature diagram of the lens apparatus of FIG. 7 at the wide-angle end;

FIG. 8B is a distortion diagram of the lens apparatus of FIG. 7 at the wide-angle end;

FIG. 8C is a relative illumination diagram of the lens apparatus of FIG. 7 at the wide-angle end;

FIG. 8D is a modulation transfer function diagram of the lens apparatus of FIG. 7 at the wide-angle end;

FIG. 8E is a modulation transfer function diagram of the lens apparatus of FIG. 7 at a telephoto end;

FIG. 8F is a through focus modulation transfer function diagram of the lens apparatus of FIG. 7 at the wide-angle end;

FIG. 8G is a through focus modulation transfer function diagram of the lens apparatus of FIG. 7 at the telephoto end.

### DETAILED DESCRIPTION OF THE INVENTION

A lens apparatus in accordance with many embodiments of the invention includes a first lens group, a second lens group, a third lens group and a fourth lens group. The first lens group includes a first lens with negative refractive power and a second lens with negative refractive power, and the first lens includes a convex surface facing an image side and a concave surface facing an objective side. The second lens group includes a third lens with positive refractive power, and the third lens includes a convex surface facing the objective side. The third lens group includes a fourth lens with positive refractive power. The fourth lens group includes a fifth lens with negative refractive power, a sixth lens with positive refractive power and a seventh lens with positive refractive power. The seventh lens includes a convex surface facing the image side. The first lens, the second lens, the third lens, the fourth lens, the fifth lens, the sixth lens and the seventh lens are arranged in order from the image side to the objective side along an optical axis.

In one or more embodiments of the invention, the first lens group is with negative refractive power.

In one or more embodiments of the invention, the first lens group can include more lenses. For example, the first lens group can further include an eighth lens with positive refractive power and disposed between the image side and the first lens.

In one or more embodiments of the invention, the second lens group is with positive refractive power.

In one or more embodiments of the invention, the third lens group is with positive refractive power.

In one or more embodiments of the invention, the fourth lens group is with positive refractive power.

In one or more embodiments of the invention, the fourth lens group can further include a stop disposed between the third lens group and the fifth lens.

In one or more embodiments of the invention, at least one lens of at least one of the first to fourth lens groups can includes a spherical surface.

In one or more embodiments of the invention, at least one lens of at least one of the first to fourth lens groups can includes at least one aspheric surface. The aspheric surface sag z of each lens can be calculated by the following formula:

z=ch²/{1+[1−(k+1)c²h²]^{1/2}}+Ah⁴+Bh⁶+Ch⁸+Dh¹⁰+Eh¹²+Fh¹⁴+Gh¹⁶

where c is a curvature, h is a vertical distance from any points on lens surface to the optical axis, k is a conic constant, and A-G are aspheric coefficients.

In one or more embodiments of the invention, all of the lenses of the first lens group are made of glass material, or parts of the lenses are made of glass material. Alternatively, the aspheric lenses in the lens apparatus are made of glass material or plastic material.

In one or more embodiments of the invention, the lens apparatus is a zoom lens or a prime lens.

The lens apparatus of the invention satisfies at least one of the following conditions:

−2.28<f_{LG1}/f<−0.59 (1)

1.5≤Vd₆/Vd₃≤4.5 (2)

29 mm<|f₁+f₃|<90 mm (3)

−44.4 mm<f₁+f₃<90 mm (4)

1.77<f₃/f<12 (5)

−9.6≤TTL/f_{LG1}≤−5.19 (6)

8.16 mm<|T_{S1ST}−T_{S3S10}|<22.92 mm (7)

8.16 mm<T_{S1ST}−T_{S3S10}<22.92 mm (8)

5.22<T_{S1ST}/T_{STS15}<8.23 (9)

−2.54<T7ob/f_{LG1}<−1.3 (10)
wherein f is an effective focal length of the lens apparatus, f_{LG1} is an effective focal length of the first lens group, f₁ is a focal length of the first lens, f₃ is a focal length of the third lens, Vd₃ is an Abbe number of the third lens, Vd₆ is an Abbe number of the sixth lens, TTL is a distance between an image side surface of a lens closest to the image side and an objective side surface of the seventh lens along the optical axis, T_{S1ST} is a distance between the image side surface of the lens closest to the image side and the stop along the optical axis, T_{S3S10} is a distance between an image side surface of the second lens and an image side surface of the fifth lens along the optical axis, T_{STS15} is a distance between the stop and the objective side surface of the seventh lens along the optical axis, and T7ob is a distance between the objective side surface of the seventh lens and an object along the optical axis.

By such arrangement, the lens apparatus can be effectively improved to have a reduced diameter, increased brightness, increased resolution and corrected aberration.

In the above-described conditions, if the condition (1) is modified to be −1.9<f_{LG1}/f<−0.74, then a better effect is obtained.

In the above-described conditions, if the condition (2) is modified to be 2≤Vd₆/Vd₃≤4 or 2.4≤Vd₆/Vd₃≤3.6, then a better effect is obtained.

In the above-described conditions, if the condition (3) is modified to be 37 mm≤f₁+f₃≤75 mm, than a better effect is obtained.

In the above-described conditions, if the condition (4) is modified to be −37 mm≤f₁+f₃≤75 mm, then a better effect is obtained.

In the above-described conditions, if the condition (5) is modified to be 2.21≤f₃/f<10.82, then a better effect is obtained.

In the above-described conditions, if the condition (6) is modified to be −8≤TTL/f_{LG1}≤−5.19, then a better effect is obtained.

In the above-described conditions, if the condition (7) is modified to be 10.2 mm≤|T_{S1ST}−T_{S3S10}|≤19.1 mm, then a better effect is obtained.

In the above-described conditions, if the condition (8) is modified to be 10.2 mm≤T_{S1ST}−T_{S3S10}≤19.1 mm, then a better effect is obtained.

In the above-described conditions, if the condition (9) is modified to be 6≤T_{S1ST}/T_{STS15}≤7, then a better effect is obtained.

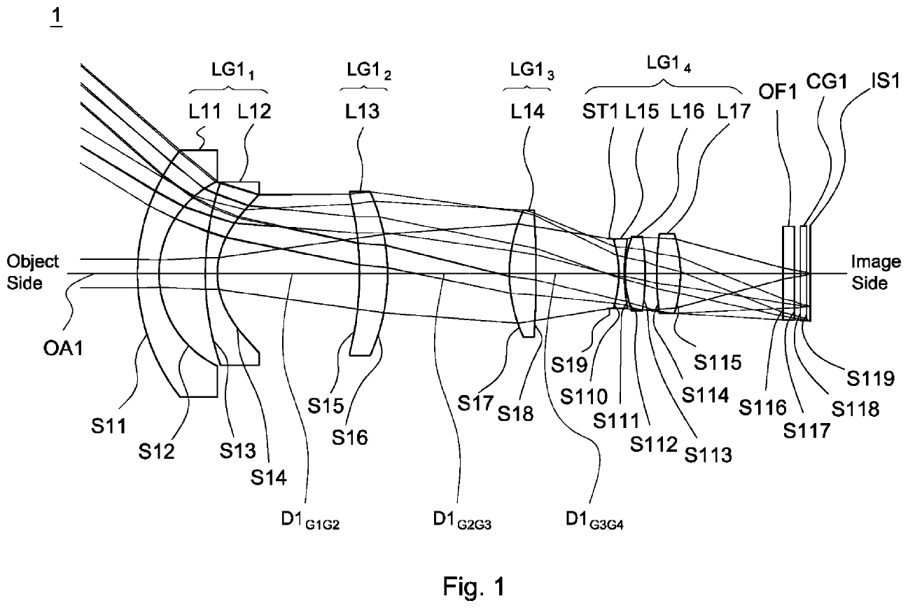

A lens apparatus in accordance with a first embodiment of the invention is described herein. Referring to FIG. 1, a lens apparatus 1 includes a first lens group LG1₁, a second lens group LG1₂, a third lens group LG1₃, a fourth lens group LG1₄, an optical filter OF1 and a cover glass CG1. The first lens group LG1₁ is with negative refractive power and includes a first lens L11 and a second lens L12. The second lens group LG1₂ is with positive refractive power and includes a third lens L13. The third lens group LG1₃ is with positive refractive power and includes a fourth lens L14. The fourth lens group LG1₄ is with positive refractive power and includes a stop ST1, a fifth lens L15, a sixth lens L16 and a seventh lens L17. The first lens L11, the second lens L12, the third lens L13, the fourth lens L14, the stop ST1, the fifth lens L15, the sixth lens L16 and the seventh lens L17 are arranged in order from an image side to an objective side along an optical axis OA1.

The first lens L11 can be, for example, with negative refractive power. The first lens L11 can be, for example, a meniscus lens, an image side surface S11 thereof can be, for example, a convex surface, and an objective side surface S12 thereof can be, for example, a concave surface. The image side surface S11 can be, for example, a spherical surface, and the objective side surface S12 can be, for example, a spherical surface.

The second lens L12 can be, for example, with negative refractive power. The second lens L12 can be, for example, a meniscus lens, an image side surface S13 thereof can be, for example, a convex surface, and an objective side surface S14 thereof can be, for example, a concave surface. The image side surface S13 can be, for example, an aspheric surface, and the objective side surface S14 can be, for example, an aspheric surface.

The third lens L13 can be, for example, with positive refractive power. The third lens L13 can be, for example, a meniscus lens, an image side surface S15 thereof can be, for example, a concave surface, and an objective side surface S16 thereof can be, for example, a convex surface. The image side surface S15 can be, for example, a spherical surface, and the objective side surface S16 can be, for example, a spherical surface.

The fourth lens L14 can be, for example, with positive refractive power. The fourth lens L14 can be, for example, a biconvex lens, an image side surface S17 thereof can be, for example, a convex surface, and an objective side surface S18 thereof can be, for example, a convex surface. The image side surface S17 can be, for example, a spherical surface, and the objective side surface S18 can be, for example, a spherical surface.

The fifth lens L15 can be, for example, with negative refractive power. The fifth lens L15 can be, for example, a biconcave lens, an image side surface S110 thereof can be, for example, a concave surface, and an objective side surface S111 thereof can be, for example, a concave surface. The image side surface S110 can be, for example, a spherical surface, and the objective side surface S111 can be, for example, a spherical surface.

The sixth lens L16 can be, for example, with positive refractive power. The sixth lens L16 can be, for example, a planoconvex lens, an image side surface S112 thereof can be, for example, a convex surface, and an objective side surface S113 thereof can be, for example, a flat surface. The image side surface S112 can be, for example, a spherical surface, and the objective side surface S113 can be, for example, a spherical surface.

The seventh lens L17 can be, for example, with positive refractive power. The seventh lens L17 can be, for example, a biconvex lens, an image side surface S114 thereof can be, for example, a convex surface, and an objective side surface S115 thereof can be, for example, a convex surface. The image side surface S114 can be, for example, an aspheric surface, and the objective side surface S115 can be, for example, an aspheric surface.

An objective side surface S116 of the optical filter OF1 can be, for example, a flat surface, and an image side surface S117 of the optical filter OF1 can be, for example, a flat surface.

An objective side surface S118 of the cover glass CG1 can be, for example, a flat surface, and an image side surface S119 of the cover glass CG1 can be, for example, a flat surface.

By the design of the above lenses, the stop ST1 and at least one of the conditions (1)-(10) satisfied, the lens apparatus 1 is able to have the lens diameter effectively reduced, brightness and resolution effectively increased, and aberration effectively corrected.

During operation, light from an object IS1 travels to the image side finally. By changing a distance D1_{G1G2} between the first lens group LG1₁ and the second lens group LG1₂, a distance D1_{G2G3} between the second lens group LG1₂ and the third lens group LG1₃ and a distance D1_{G3G4} between the third lens group LG1₃ and the fourth lens group LG1₄, the effective focal length of the lens apparatus 1 can be adjusted. When the first lens group LG1₁ is moved along the optical axis OA1 to change the distance D1_{G1G2} and/or the distance D1_{G2G3}, the lens apparatus 1 is focusing. In order to achieve the above purposes and effectively enhance the optical performance, the lens apparatus 1 in accordance with the first embodiment of the invention is provided with the optical specifications shown in Table 1, which include curvature of each lens surface, distance between adjacent surface, refractive index of each lens, Abbe number of each lens and focal length of each lens. Table 1 shows that the lens apparatus 1 at a wide-angle end has the effective focal length equal to 9.7 mm and F-number equal to 1.94, and the lens apparatus 1 at a telephoto end has the effective focal length equal to 11.6 mm and F-number equal to 2.04.

TABLE 1

| | | | | | Focal | |
|---|---|---|---|---|---|---|
| Surface | Curvature | Distance | | | Length | |
| Number | (mm⁻¹) | (mm) | Nd | Vd | (mm) | Remark |
| S11 | 0.03 | 3.7 | 1.74 | 45.00 | −55.531 | The First |
| | | | | | | Lens L11 |
| S12 | 0.06 | 8.1 | | | | |
| S13 | 0.02 | 2.2 | 1.60 | 60.00 | −29.056 | The Second |
| | | | | | | Lens L12 |
| S14 | 0.08 | 24.8 | | | | Distance |
| | | (The Wide- | | | | D1_{G1G2} |
| | | Angle End) | | | | |
| | | 21.0 | | | | |
| | | (The | | | | |
| | | Telephoto | | | | |
| | | End) | | | | |
| S15 | −0.02 | 4.9 | 1.76 | 27.00 | 104.935 | The Third |
| | | | | | | Lens L13 |
| S16 | −0.03 | 21.3 | | | | Distance |
| | | (The Wide- | | | | D1_{G2G3} |
| | | Angle End) | | | | |
| | | 13.1 | | | | |
| | | (The | | | | |
| | | Telephoto | | | | |
| | | End) | | | | |
| S17 | 0.04 | 4.7 | 1.62 | 60.00 | 33.214 | The Fourth |
| | | | | | | Lens L14 |
| S18 | −0.01 | 12.9 | | | | |
| | | (The Wide- | | | | Distance |
| | | Angle End) | | | | D1_{G3G4} |
| | | 14.5 | | | | |
| | | (The | | | | |
| | | Telephoto | | | | |
| | | End) | | | | |
| S19 | 0.00 | 1.6 | | | | The Stop |
| | | | | | | ST1 |
| S110 | −0.05 | 1.0 | 1.75 | 28.00 | −16.403 | The Fifth |
| | | | | | | Lens L15 |
| S111 | 0.03 | 0.1 | | | | |
| S112 | 0.06 | 3.5 | 1.50 | 81.00 | 33.33 | The Sixth |
| | | | | | | Lens L16 |
| S113 | 0.00 | 2.0 | | | | |
| S114 | 0.02 | 4.2 | 1.60 | 60.00 | 24.931 | The Seventh |
| | | | | | | Lens L17 |
| S115 | −0.05 | 17.9 | | | | |
| | | (The Wide- | | | | |
| | | Angle End) | | | | |
| | | 19.6 | | | | |
| | | (The | | | | |
| | | Telephoto | | | | |
| | | End) | | | | |
| S116 | 0.00 | 2.0 | 1.52 | 58.00 | | The Optical |
| | | | | | | Filter OF1 |
| S117 | 0.00 | 1.0 | | | | |
| S118 | 0.00 | 1.1 | 1.51 | 62.00 | | The Cover |
| | | | | | | Glass CG1 |
| S119 | 0.00 | 0.7 | | | | |

Table 2 shows that the optical specifications of the aspheric surface of each lens shown in Table 1, wherein k is a conic constant and A-G are aspheric coefficients.

TABLE 2

| Surface | | | | |
|---|---|---|---|---|
| Number | S13 | S14 | S114 | S115 |
| k | −0.52 | −1.1 | 7.35 | 0.3 |
| A | 4.87E−06 | 2.56E−05 | −7.16E−05 | 2.59E−05 |
| B | −2.45E−08 | −8.36E−08 | 2.13E−07 | 4.22E−07 |
| C | −2.17E−10 | −3.14E−10 | −8.13E−09 | −9.26E−09 |
| D | 1.37E−12 | 9.96E−13 | 1.23E−10 | 1.43E−10 |
| E | −7.32E−16 | −2.34E−16 | 0.00E+00 | 0.00E+00 |
| F | −1.51E−17 | −2.72E−17 | 0.00E+00 | 0.00E+00 |
| G | 3.48E−20 | 1.06E−19 | 0.00E+00 | 0.00E+00 |

Table 3 shows the optical specifications of the lens apparatus 1 and calculated values corresponding to the conditions (1)-(10). It can be seen from Table 3 that the lens apparatus 1 can meet requirements of the conditions (1)-(10).

TABLE 3

| f_{LG1} | −18.3 | mm | TTL (The Wide- | 95 | mm | TTL (The | 84.6 | mm |
|---|---|---|---|---|---|---|---|---|
| | | | Angle End) | | | Telephoto End) | | |
| T_{S1ST} (The Wide- | 82.6 | mm | T_{S1ST} (The | 72.2 | mm | T_{S3S10} (The Wide- | 72.4 | mm |
| Angle End) | | | Telephoto End) | | | Angle End) | | |
| T_{S3S10} (The | 62 | mm | T_{STS15} (The Wide- | 12.4 | mm | T_{STS15} (The | 12.4 | mm |
| Telephoto End) | | | Angle End) | | | Telephoto End) | | |
| f_{LG1}/f (The Wide- | −1.89 | | f_{LG1}/f (The | −1.58 | | Vd₆/Vd₃ | 3 | |
| Angle End) | | | Telephoto End) | | | | | |
| \|f₁ + f₃\| | 49.40 | mm | f₁ + f₃ | 49.40 | mm | f₃/f (The Wide- | 10.82 | |
| | | | | | | Angle End) | | |
| f₃/f (The | 9.05 | | TTL/f_{LG1} (The | −5.19 | | TTL/f_{LG1} (The | −4.62 | |
| Telephoto End) | | | Wide-Angle End) | | | Telephoto End) | | |
| \|T_{S1ST} − T_{S3S10}\| | 10.2 | mm | \|T_{S1ST} − T_{S3S10}\| | 10.2 | mm | T_{S1ST} − T_{S3S10} | 10.2 | mm |
| (The Wide-Angle | | | (The Telephoto | | | (The Wide-Angle | | |
| End) | | | End) | | | End) | | |

| T_{S1ST} − T_{S3S10}(The | 10.2 | mm | T_{S1ST}/T_{STS15} (The | 6.66 | | T_{S1ST}/T_{STS15} | 5.82 |
|---|---|---|---|---|---|---|---|
| Telephoto End) | | | Wide-Angle End) | | | (The Telephoto | |
| | | | | | | End) | |
| T7ob (The Wide- | 22.7 | mm | T7ob (The | 24.4 | mm | T7ob/f_{LG1} (The | −1.24 |
| Angle End) | | | Telephoto End) | | | Wide-Angle End) | |

| | |
|---|---|
| T7ob/f_{LG1} (The | −1.33 |
| Telephoto End) | |

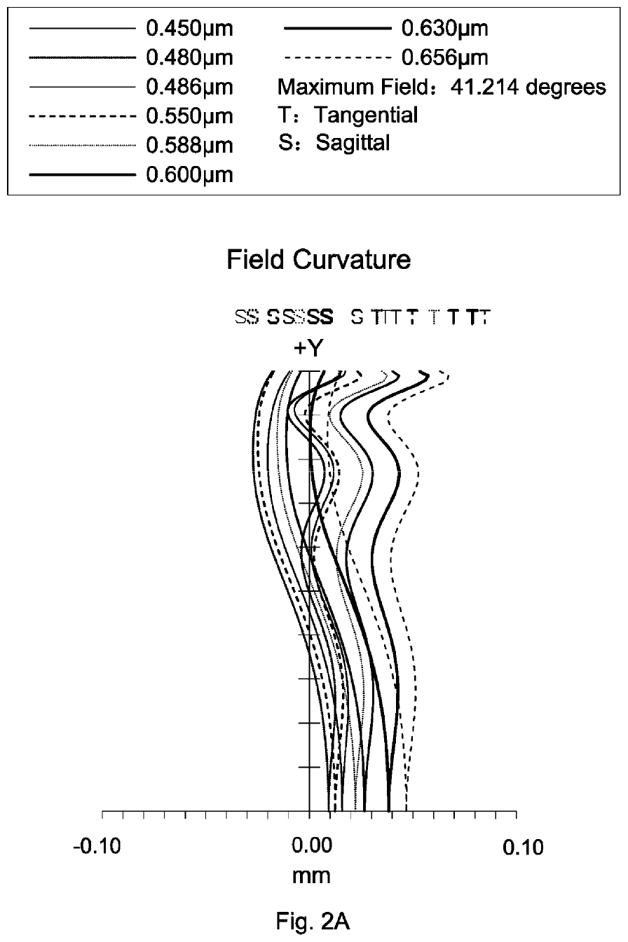

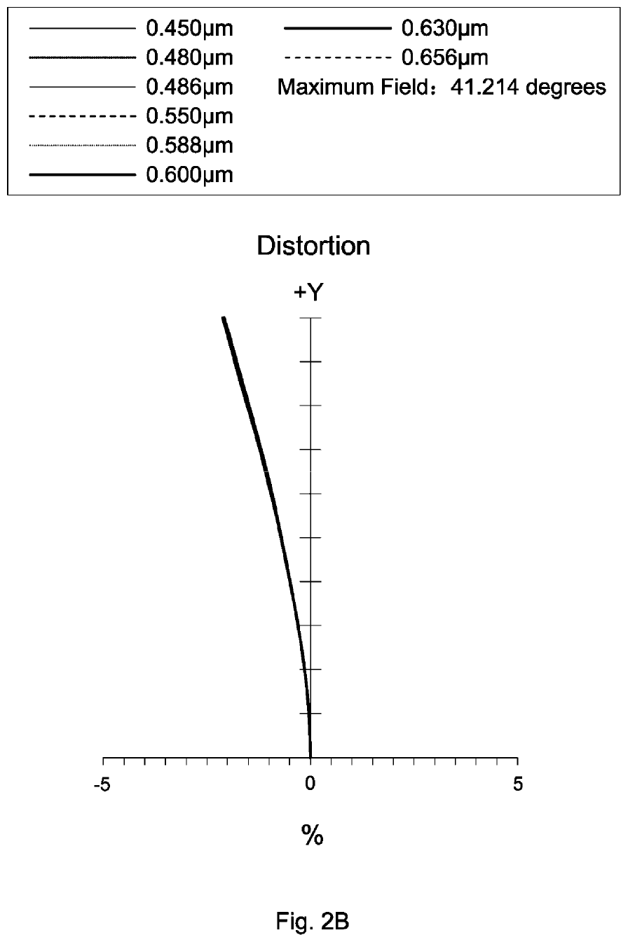

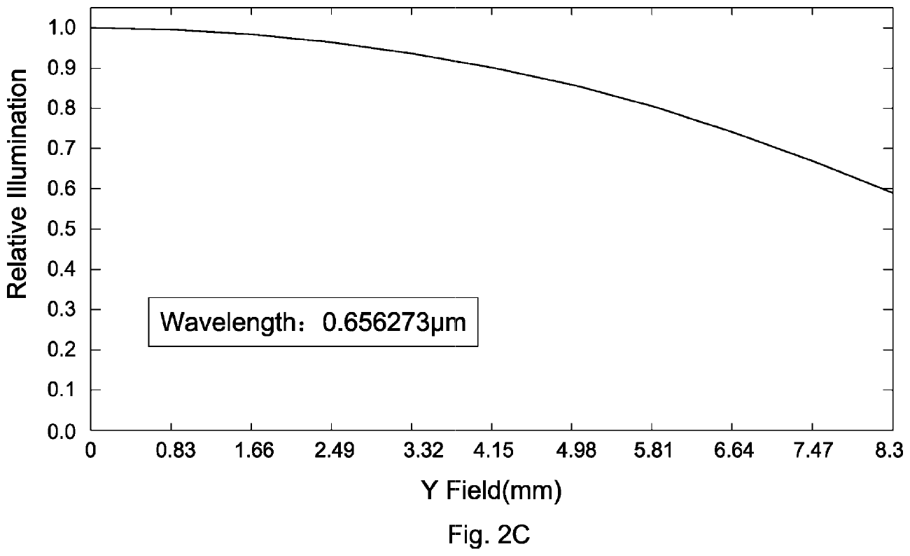

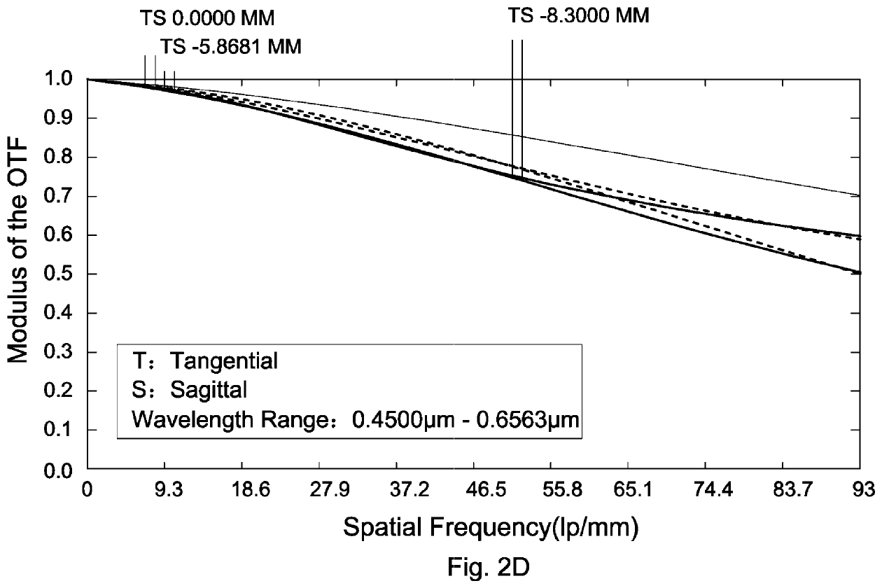

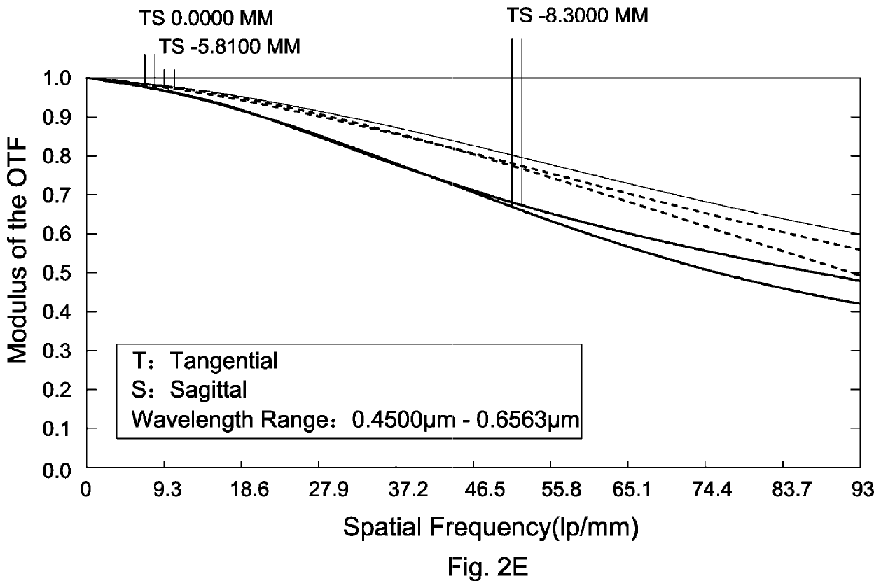

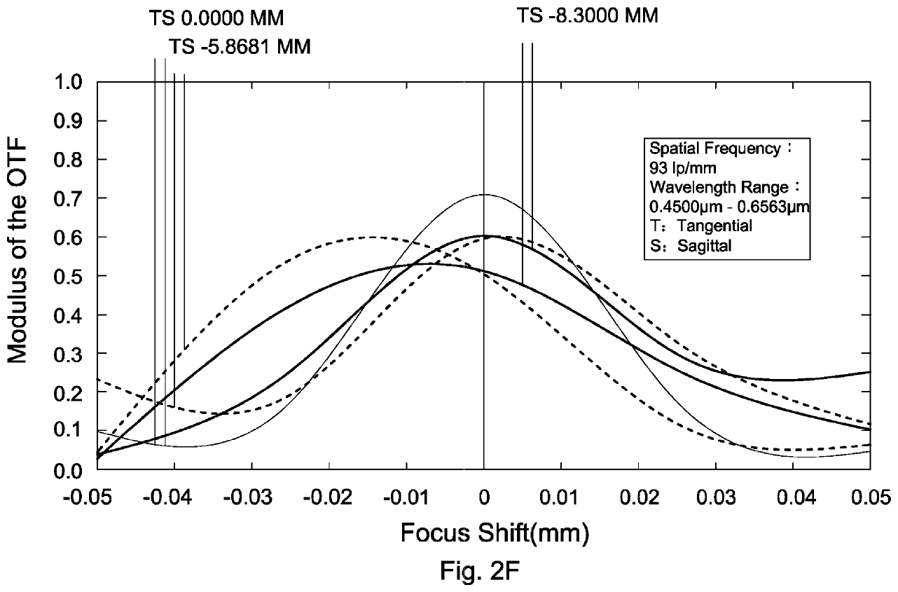

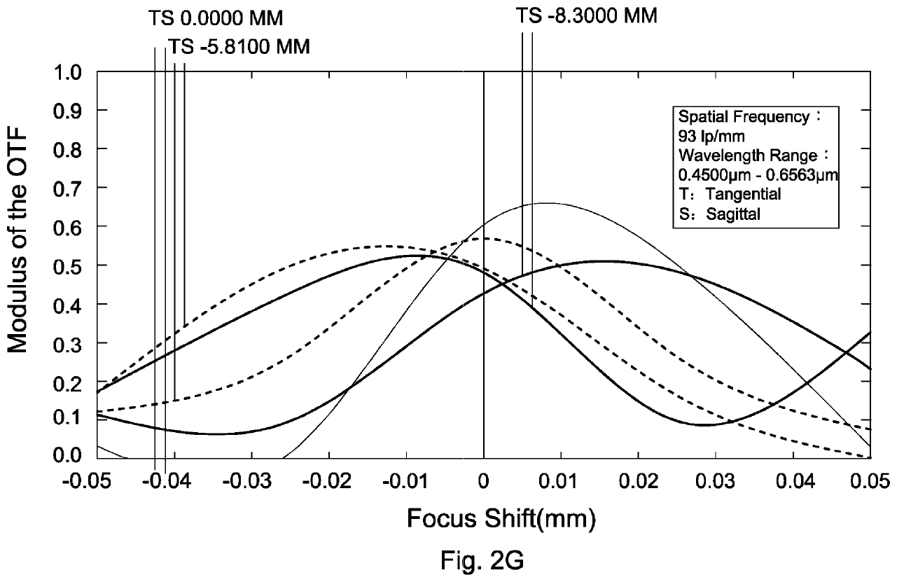

It can be seen from FIGS. 2A-2G that the lens apparatus 1 also meets the requirements of optical performance.

It can be seen from FIG. 2A that a field curvature of the lens apparatus 1 at the wide-angle end ranges from −0.03 mm to 0.06 mm. It can be seen from FIG. 2B that a distortion of the lens apparatus 1 at the wide-angle end ranges from −2.1% to 0%. It can be seen from FIG. 2C that a relative illumination of the lens apparatus 1 at the wide-angle end ranges from 0.92 to 1.0. It can be seen from FIG. 2D that a modulation transfer function of the lens apparatus 1 at the wide-angle end ranges from 0.49 to 1.0. It can be seen from FIG. 2E that a modulation transfer function of the lens apparatus 1 at the telephoto end ranges from 0.41 to 1.0. It can be seen from FIG. 2F that the modulation transfer function of the lens apparatus 1 at the wide-angle end ranges from 0 to 0.72 as a focus shift ranges between −0.05 mm and 0.05 mm. It can be seen from FIG. 2G that the modulation transfer function of the lens apparatus 1 at the telephoto end ranges from 0 to 0.67 as a focus shift ranges between −0.05 mm and 0.05 mm.

It is obvious that the field curvature and the distortion of the lens apparatus 1 can be corrected effectively, and the relative illumination, the resolution and the depth of focus of the lens apparatus 1 can meet the requirements. Therefore, the lens apparatus 1 is capable of good optical performance.

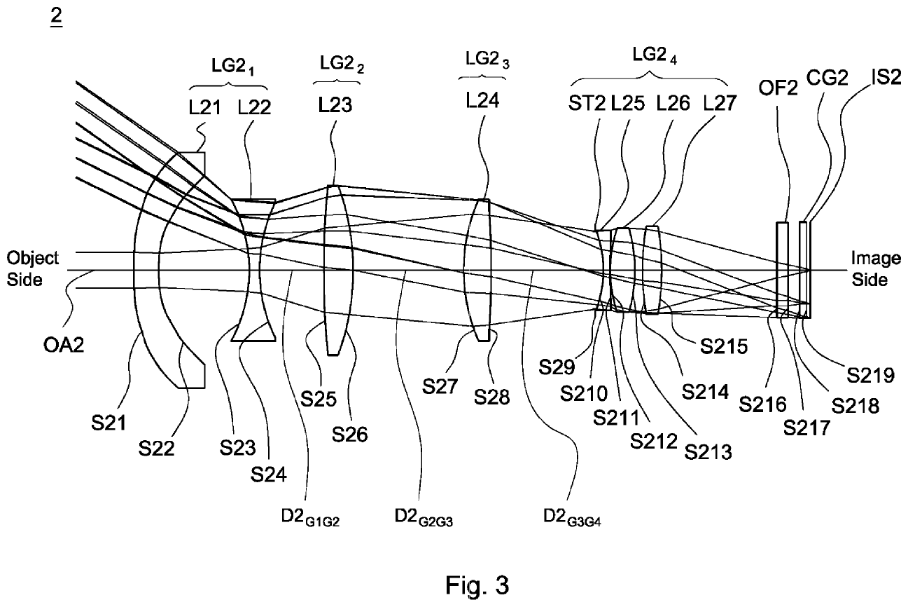

Referring to FIG. 3, FIG. 3 is a lens layout and optical path diagram of a lens apparatus in accordance with a second embodiment of the invention. A lens apparatus 2 includes a first lens group LG2₁, a second lens group LG2₂, a third lens group LG2₃, a fourth lens group LG2₄, an optical filter OF2 and a cover glass CG2. The first lens group LG2₁ includes a first lens L21 and a second lens L22. The second lens group LG2₂ includes a third lens L23. The third lens group LG2₃ includes a fourth lens L24. The fourth lens group LG2₄ includes a stop ST2, a fifth lens L25, a sixth lens L26 and a seventh lens L27. The first lens L21, the second lens L22, the third lens L23, the fourth lens L24, the stop ST2, the fifth lens L25, the sixth lens L26 and the seventh lens L27 are arranged in order from an image side to an objective side along an optical axis OA2.

The difference between the second embodiment and the first embodiment as shown in FIG. 1 is described herein. An image side surface S21 of the first lens L21 can be, for example, an aspheric surface, and an objective side surface S22 of the first lens L21 can be, for example, an aspheric surface. An image side surface S23 of the second lens L22 can be, for example, a concave surface and a spherical surface, and an objective side surface S24 of the second lens L22 can be, for example, a spherical surface. An image side surface S25 of the third lens L23 can be, for example, a convex surface. An image side surface S28 of the fourth lens L24 can be, for example, a flat surface. The other elements of the lens apparatus 2 of the second embodiment as shown in FIG. 3 are similar to those of the lens apparatus 1 as shown in FIG. 1, and therefore the descriptions thereof are omitted.

By the design of the above lenses, the stop ST2 and at least one of the conditions (1)-(10) satisfied, the lens apparatus 2 is able to have the lens diameter effectively reduced, brightness and resolution effectively increased, and aberration effectively corrected.

During operation, light from an object IS2 travels to the image side finally. By changing a distance D2_{G1G2} between the first lens group LG2₁ and the second lens group LG2₂, a distance D2_{G2G3} between the second lens group LG2₂ and the third lens group LG2₃ and a distance D2_{G3G4} between the third lens group LG2₃ and the fourth lens group LG2₄, the effective focal length of the lens apparatus 2 can be adjusted. When the first lens group LG2₁ is moved along the optical axis OA2 to change the distance D2_{G1G2}, the lens apparatus 2 is focusing.

In order to achieve the above purposes and effectively enhance the optical performance, the lens apparatus 2 of the second embodiment of the invention is provided with the optical specifications shown in Table 4, which include curvature of each lens surface, distance between adjacent surface, refractive index of each lens, Abbe number of each lens and effective focal length of each lens. Table 4 shows that the lens apparatus 2 at a wide-angle end has the effective focal length equal to 12.0 mm and F-number equal to 1.94, and the lens apparatus 2 at a telephoto end has the effective focal length equal to 15.4 mm and F-number equal to 2.13.

TABLE 4

| | | | | | Effective | |
|---|---|---|---|---|---|---|
| | | | | | Focal | |
| Surface | Curvature | Distance | | | Length | |
| Number | (mm⁻¹) | (mm) | Nd | Vd | (mm) | Remark |
| S21 | 0.02 | 4.3 | 1.52 | 56.00 | −71.073 | The First |
| | | | | | | Lens L21 |
| S22 | 0.05 | 15.6 | | | | |
| S23 | −0.04 | 1.8 | 1.75 | 28.00 | −16.168 | The Second |
| | | | | | | Lens L22 |
| S24 | 0.04 | 11.0 | | | | The |
| | | (The Wide- | | | | Distance |
| | | Angle End) | | | | D2_{G1G2} |
| | | 9.9 | | | | |
| | | (The | | | | |
| | | Telephoto | | | | |
| | | End) | | | | |
| S25 | 0.01 | 5.2 | 1.76 | 27.00 | 34.041 | The Third |
| | | | | | | Lens L23 |
| S26 | −0.03 | 19.0 | | | | The |
| | | (The Wide- | | | | Distance |
| | | Angle End) | | | | D2_{G2G3} |
| | | 3.4 | | | | |
| | | (The | | | | |
| | | Telephoto | | | | |
| | | End) | | | | |
| S27 | 0.03 | 4.7 | 1.60 | 60.00 | 55.556 | The Fourth |
| | | | | | | Lens L24 |
| S28 | 0.00 | 18.0 | | | | The |
| | | (The Wide- | | | | Distance |
| | | Angle End) | | | | D2_{G3G4} |
| | | 21.5 | | | | |
| | | (The | | | | |
| | | Telephoto | | | | |
| | | End) | | | | |
| S29 | 0.00 | 1.4 | | | | The Stop |
| | | | | | | ST2 |
| S210 | −0.06 | 1.2 | 1.80 | 25.00 | −17.695 | The Fifth |
| | | | | | | Lens L25 |
| S211 | 0.01 | 0.1 | | | | |
| S212 | 0.04 | 4.2 | 1.50 | 81.00 | 50 | The Sixth |
| | | | | | | Lens L26 |
| S213 | 0.00 | 1.3 | | | | |
| S214 | 0.02 | 3.4 | 1.51 | 64.00 | 40.327 | The Seventh |
| | | | | | | Lens L27 |
| S215 | −0.03 | 19.7 | | | | |
| | | (The Wide- | | | | |
| | | Angle End) | | | | |
| | | 23.2 | | | | |
| | | (The | | | | |
| | | Telephoto | | | | |
| | | End) | | | | |
| S216 | 0.00 | 2.0 | 1.52 | 58.00 | | The Optical |
| | | | | | | Filter OF2 |
| S217 | 0.00 | 1.0 | | | | |
| S218 | 0.00 | 1.1 | 1.51 | 62.00 | | Cover Glass |
| | | | | | | CG2 |
| S219 | 0.00 | 0.7 | | | | |

Table 5 shows that the optical specifications of the aspheric surface of each lens shown in Table 4, wherein k is a conic constant and A-G are aspheric coefficients.

TABLE 5

| Surface | | | | |
|---|---|---|---|---|
| Number | S21 | S22 | S214 | S215 |
| k | 3.5 | 0.5 | 8.13 | 0 |
| A | 3.35E−05 | 3.08E−05 | −3.61E−05 | 4.36E−05 |
| B | −9.17E−08 | −1.05E−07 | 2.27E−07 | 3.33E−07 |
| C | 1.72E−10 | −1.30E−10 | 1.18E−10 | 1.89E−09 |
| D | −1.47E−14 | −1.69E−13 | 3.21E−11 | −2.36E−11 |
| E | −2.11E−16 | 5.34E−15 | −4.85E−13 | 1.19E−12 |
| F | −1.91E−20 | −1.02E−17 | 9.04E−15 | −1.38E−14 |
| G | 5.24E−22 | −4.35E−20 | −3.93E−17 | 9.32E−17 |

Table 6 shows the optical specifications of the lens apparatus 2 and calculated values corresponding to the conditions (1)-(10). It can be seen from Table 6 that the lens apparatus 2 can meet requirements of the conditions (1)-(10).

TABLE 6

| f_{LG1} | −11.4 | mm | TTL (The Wide- | 91.2 | mm | TTL (The | 78.2 mm |
|---|---|---|---|---|---|---|---|
| | | | Angle End) | | | Telephoto End) | |
| T_{S1ST} (The Wide- | 79.6 | mm | T_{S1ST} (The | 66.6 | mm | T_{S3S10} (The Wide- | 61.1 mm |
| Angle End) | | | Telephoto End) | | | Angle End) | |
| T_{S3S10} (The | 47.9 | mm | T_{STS15} (The Wide- | 11.6 | mm | T_{STS15} (The | 11.6 mm |
| Telephoto End) | | | Angle End) | | | Telephoto End) | |
| f_{LG1}/f (The | −0.95 | | f_{LG1}/f (The | −0.74 | | Vd₆/Vd₃ | 3 |
| Wide-Angle End) | | | Telephoto End) | | | | |
| \|f₁ + f₃\| | 37.03 | mm | f₁ + f₃ | −37.032 | mm | f₃/f (The Wide- | 2.84 |
| | | | | | | Angle End) | |
| f₃/f (The | 2.21 | | TTL/f_{LG1} (The | −8.00 | | TTL/f_{LG1} (The | −6.86 |
| Telephoto End) | | | Wide-Angle End) | | | Telephoto End) | |
| \|T_{S1ST} − T_{S3S10}\| | 18.5 | mm | \|T_{S1ST} − T_{S3S10}\| | 18.7 | mm | T_{S1ST} − T_{S3S10} | 18.5 mm |
| (The Wide-Angle | | | (The Telephoto | | | (The Wide-Angle | |
| End) | | | End) | | | End) | |
| T_{S1ST} − T_{S3S10} | 18.7 | mm | T_{S1ST}/T_{STS15} (The | 6.86 | | T_{S1ST}/T_{STS15} | 5.74 |
| (The Telephoto | | | Wide-Angle End) | | | (The Telephoto | |
| End) | | | | | | End) | |
| T7ob (The Wide- | 24.5 | mm | T7ob (The | 28.0 | mm | T7ob/f_{LG1} (The | −2.14 |
| Angle End) | | | Telephoto End) | | | Wide-Angle End) | |

| | |
|---|---|
| T7ob/f_{LG1} (The | −2.45 |
| Telephoto End) | |

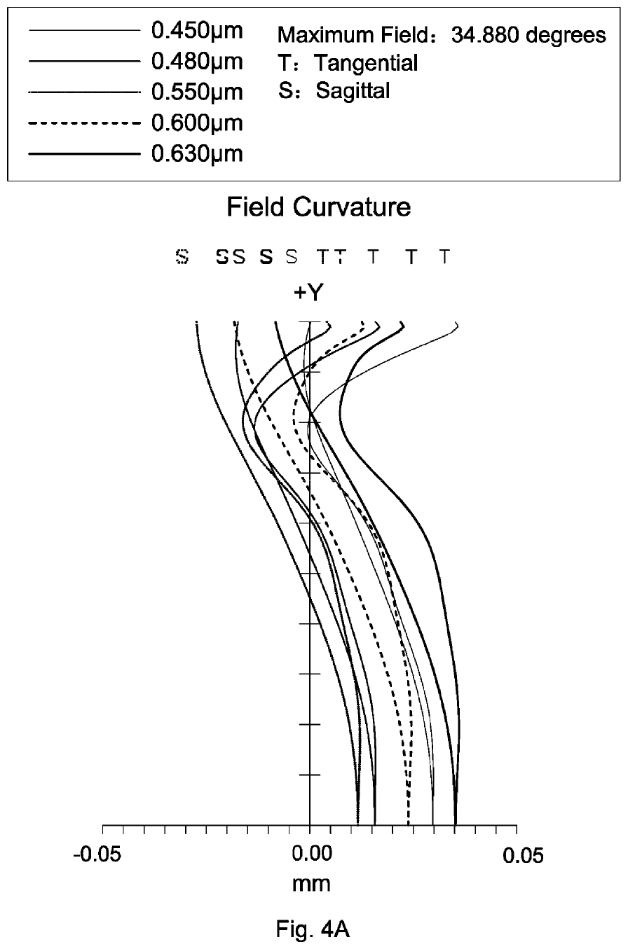

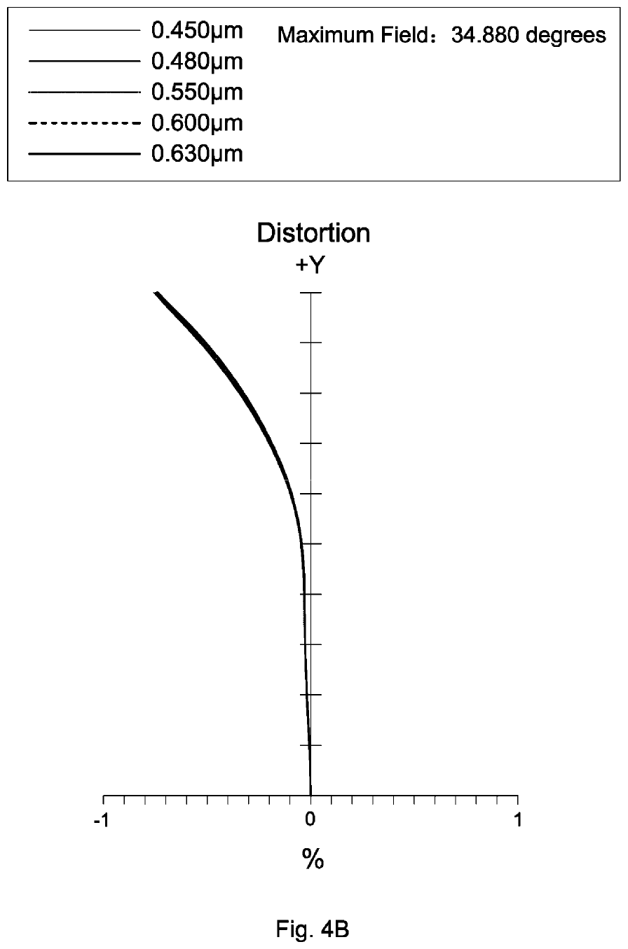

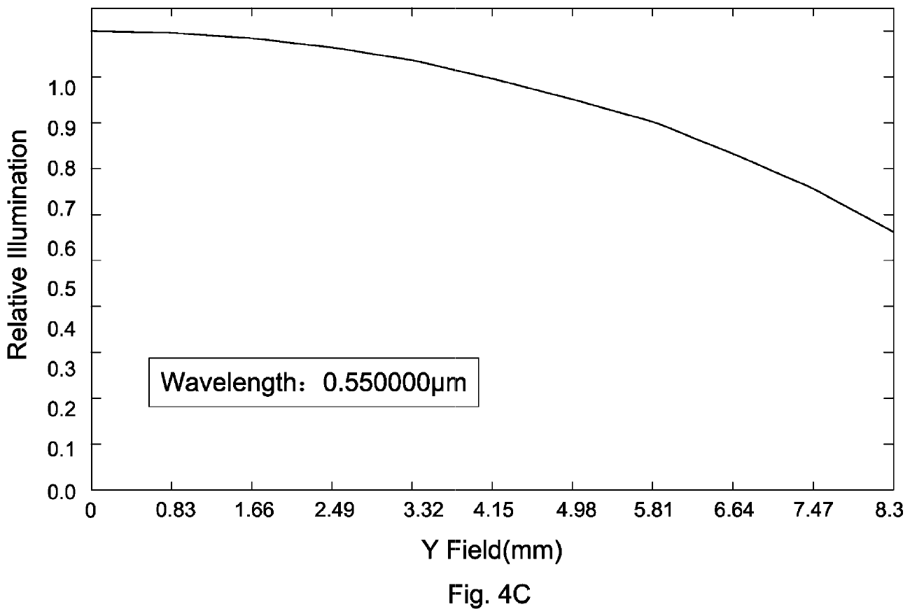

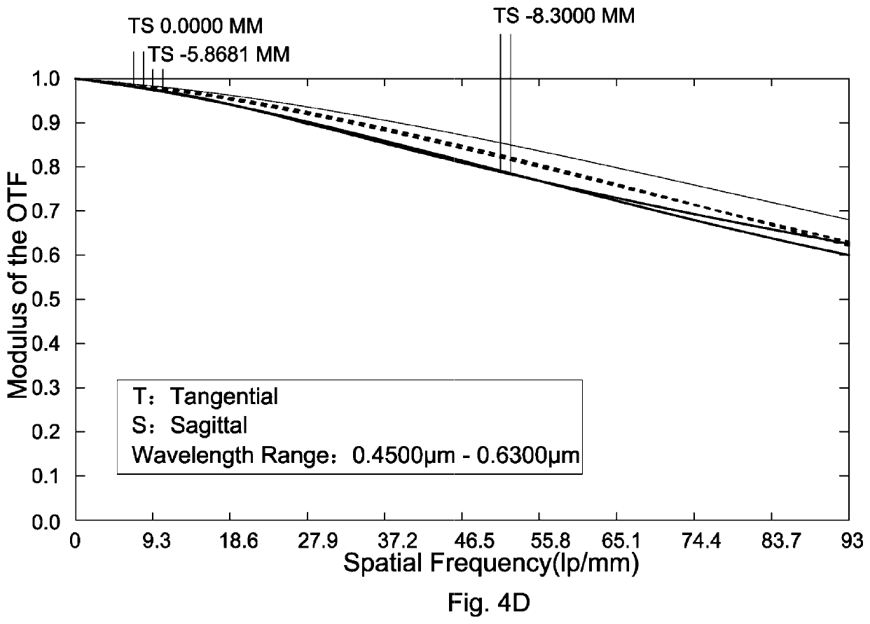

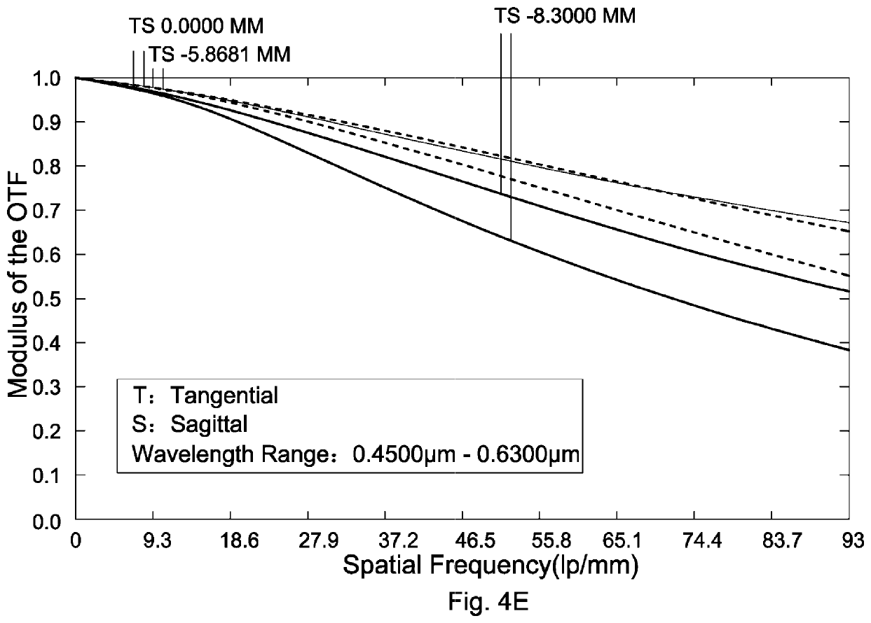

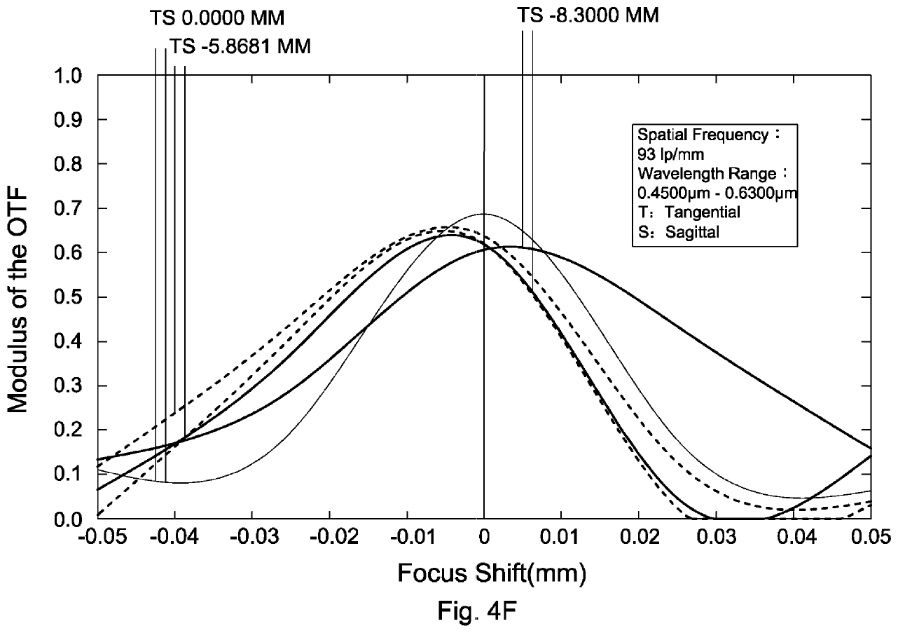

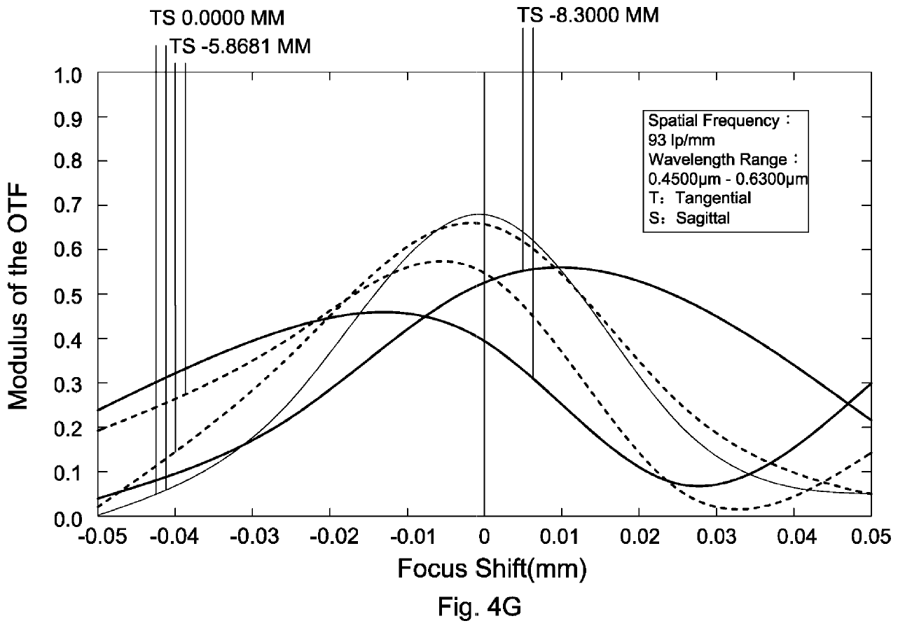

The lens apparatus 2 can also meet the requirements of optical performance as seen in FIGS. 4A-4G. It can be seen from FIG. 4A that a field curvature of the lens apparatus 2 at the wide-angle end ranges from −0.03 mm to 0.04 mm. It can be seen from FIG. 4B that a distortion of the lens apparatus 2 at the wide-angle end ranges from −0.8% to 0%. It can be seen from FIG. 4C that a relative illumination of the lens apparatus 2 at the wide-angle end ranges from 0.53 to 1.0. It can be seen from FIG. 4D that a modulation transfer function of the lens apparatus 2 at the wide-angle end ranges from 0.58 to 1.0. It can be seen from FIG. 4E that a modulation transfer function of the lens apparatus 2 at the telephoto end ranges from 0.38 to 1.0. It can be seen from FIG. 4F that the modulation transfer function of the lens apparatus 2 at the wide-angle end ranges from 0 to 0.70 as a focus shift ranges between −0.05 mm and 0.05 mm. It can be seen from FIG. 4G that the modulation transfer function of the lens apparatus 2 at the telephoto end ranges from 0 to 0.68 as a focus shift ranges between −0.05 mm and 0.05 mm.

It is obvious that the field curvature and the distortion of the lens apparatus 2 can be corrected effectively, and the relative illumination, the resolution and the depth of focus of the lens apparatus 2 can meet the requirements. Therefore, the lens apparatus 2 is capable of good optical performance.

In another embodiment of the invention, the fifth lens and the sixth lens of the fourth lens group can be designed to be a cemented lens.

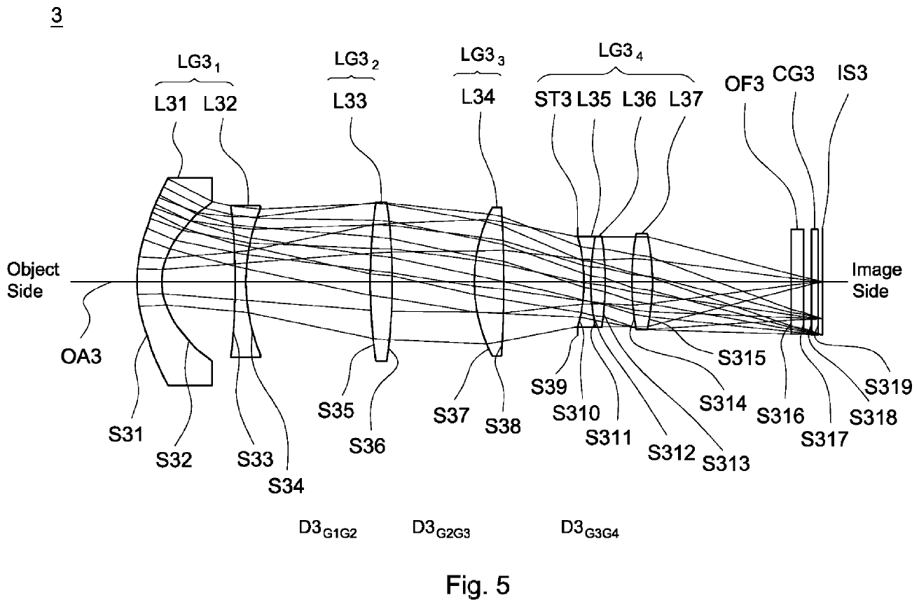

Referring to FIG. 5, FIG. 5 is a lens layout and optical path diagram of a lens apparatus in accordance with a third embodiment of the invention. A lens apparatus 3 includes a first lens group LG3₁, a second lens group LG3₂, a third lens group LG3₃, a fourth lens group LG3₄, an optical filter OF3 and a cover glass CG3. The first lens group LG3₁ includes a first lens L31 and a second lens L32. The second lens group LG3₂ includes a third lens L33. The third lens group LG3₃ includes a fourth lens L34. The fourth lens group LG3₄ includes a stop ST3, a fifth lens L35, a sixth lens L36 and a seventh lens L37. The fifth lens L35 and the sixth lens L36 are cemented together. The first lens L31, the second lens L32, the third lens L33, the fourth lens L34, the stop ST3, the fifth lens L35, the sixth lens L36 and the seventh lens L37 are arranged in order from an image side to an objective side along an optical axis OA3.

The difference between the third embodiment and the first embodiment as shown in FIG. 1 is described herein. An image side surface S31 of the first lens L31 can be, for example, an aspheric surface, and an objective side surface S32 of the first lens L31 can be, for example, an aspheric surface. An image side surface S33 of the second lens L32 can be, for example, a concave surface and a spherical surface, and an objective side surface S34 of the second lens L32 can be, for example, a spherical surface. An image side surface S35 of the third lens L33 can be, for example, a convex surface. The other elements of the lens apparatus 3 of the third embodiment as shown in FIG. 5 are similar to those of the lens apparatus 1 as shown in FIG. 1, and therefore the descriptions thereof are omitted.

By the design of the above lenses, the stop ST3 and at least one of the conditions (1)-(10) satisfied, the lens apparatus 3 is able to have the lens diameter effectively reduced, brightness and resolution effectively increased, and aberration effectively corrected.

During operation, light from an object IS3 travels to the image side finally. By changing a distance D3_{G1G2} between the first lens group LG3₁ and the second lens group LG3₂, a distance D3_{G2G3} between the second lens group LG3₂ and the third lens group LG3₃ and a distance D3_{G3G4} between the third lens group LG3₃ and the fourth lens group LG3₄, the effective focal length of the lens apparatus 3 can be adjusted. When the first lens group LG3₁ is moved along the optical axis OA3 to change the distance D3_{G1G2}, the lens apparatus 3 is focusing.

In order to achieve the above purposes and effectively enhance the optical performance, the lens apparatus 3 of the third embodiment of the invention is provided with the optical specifications shown in Table 7, which include curvature of each lens surface, distance between adjacent surface, refractive index of each lens, Abbe number of each lens and focal length of each lens. Table 7 shows that the lens apparatus 3 at a wide-angle end has the effective focal length equal to 15.4 mm and F-number equal to 1.94, and the lens apparatus 3 at a telephoto end has the effective focal length equal to 18.5 mm and F-number equal to 2.05. The fifth lens L35 and the sixth lens L36 are cemented together.

TABLE 7

| | | | | | Focal | |
|---|---|---|---|---|---|---|
| Surface | Curvature | Distance | | | Length | |
| Number | (mm⁻¹) | (mm) | Nd | Vd | (mm) | Remark |
| S31 | 0.05 | 3.9 | 1.52 | 64.00 | −42.5 | The First |
| | | | | | | Lens L31 |
| S32 | 0.10 | 11.5 | | | | |
| S33 | −0.01 | 1.7 | 1.49 | 81.00 | −48.9 | The Second |
| | | | | | | Lens L32 |
| S34 | 0.03 | 19.5 | | | | The Distance |
| | | (The Wide- | | | | D3_{G1G2} |
| | | Angle End) | | | | |
| | | 14.7 | | | | |
| | | (The | | | | |
| | | Telephoto | | | | |
| | | End) | | | | |
| S35 | 0.01 | 3.5 | 1.78 | 47.00 | 56.8 | The Third |
| | | | | | | Lens L33 |
| S36 | −0.01 | 13.0 | | | | The Distance |
| | | (The Wide- | | | | D3_{G2G3} |
| | | Angle End) | | | | |
| | | 6.3 | | | | |
| | | (The | | | | |
| | | Telephoto | | | | |
| | | End) | | | | |
| S37 | 0.04 | 4.6 | 1.49 | 81.00 | 44.3 | The Fourth |
| | | | | | | Lens L34 |
| S38 | −0.01 | 11.8 | | | | |
| | | (The Wide- | | | | The Distance |
| | | Angle End) | | | | D3_{G3G4} |
| | | 14.3 | | | | |
| | | (The | | | | |
| | | Telephoto | | | | |
| | | End) | | | | |
| S39 | 0.00 | 1.0 | | | | The Stop ST3 |
| S310 | −0.04 | 1.0 | 1.75 | 27.00 | −19.7 | The Fifth |
| | | | | | | Lens L35 |
| S311 | 0.03 | 0.0 | | | | |
| S312 | 0.03 | 2.2 | 1.49 | 81.00 | 43.86 | The Sixth |
| | | | | | | Lens L36 |
| S313 | 0.00 | 4.3 | | | | |
| S314 | 0.02 | 3.3 | 1.67 | 55.00 | 25.7 | The Seventh |
| | | | | | | Lens L37 |
| S315 | −0.03 | 21.8 | | | | |
| | | (The Wide- | | | | |
| | | Angle End) | | | | |
| | | 24.2 | | | | |
| | | (The | | | | |
| | | Telephoto | | | | |
| | | End) | | | | |
| S316 | 0.00 | 2.0 | 1.52 | 58.00 | | The Optical |
| | | | | | | Filter OF3 |
| S317 | 0.00 | 1.0 | | | | |
| S318 | 0.00 | 1.1 | 1.51 | 62.00 | | Cover Glass |
| | | | | | | CG3 |
| S319 | 0.00 | 0.7 | | | | |

Table 8 shows that the optical specifications of the aspheric surface of each lens shown in Table 7, wherein k is a conic constant and A-G are aspheric coefficients.

TABLE 8

| Surface | | | | |
|---|---|---|---|---|
| Number | S31 | S32 | S314 | S315 |
| k | −3.84 | −0.8 | −9.01 | −4.9 |
| A | −5.95E−06 | −5.27E−05 | −3.87E−07 | −1.49E−05 |
| B | 5.40E−09 | 1.19E−07 | −3.57E−08 | 2.08E−07 |
| C | 1.68E−10 | 4.80E−10 | 3.19E−09 | −6.85E−09 |
| D | −4.38E−13 | −2.79E−12 | −2.20E−10 | 1.09E−10 |
| E | −1.53E−15 | 2.38E−15 | 6.11E−12 | −8.54E−13 |
| F | 8.16E−18 | −1.73E−17 | −8.76E−14 | −2.99E−15 |
| G | −9.32E−21 | 1.75E−19 | 4.96E−16 | 5.75E−17 |

Table 9 shows the optical specifications of the lens apparatus 3 and calculated values corresponding to the conditions (1)-(10). It can be seen from Table 9 that the lens apparatus 3 can meet requirements of the conditions (1)-(10).

TABLE 9

| f_{LG1} | −20.6 | mm | TTL (The Wide- | 81.3 mm | TTL (The | 72.3 mm |
|---|---|---|---|---|---|---|
| | | | Angle End) | | Telephoto End) | |
| T_{S1ST} (The Wide- | 69.5 | mm | T_{S1ST} (The | 60.5 mm | T_{S3S10} (The Wide- | 55.1 mm |
| Angle End) | | | Telephoto End) | | Angle End) | |
| T_{S3S10} (The | 46.1 | mm | T_{STS15} (The Wide- | 11.8 mm | T_{STS15} (The | 11.8 mm |
| Telephoto End) | | | Angle End) | | Telephoto End) | |
| f_{LG1}/f (The | −1.34 | | f_{LG1}/f (The | −1.11 | Vd₆/Vd₃ | 1.72 |
| Wide-Angle End) | | | Telephoto End) | | | |
| \|f₁ + f₃\| | 14.3 | mm | f₁ + f₃ | 14.3 mm | f₃/f (The Wide- | 3.69 |
| | | | | | Angle End) | |
| f₃/f (The | 3.07 | | TTL/f_{LG1} (The | −3.95 | TTL/f_{LG1} (The | −3.51 |
| Telephoto End) | | | Wide-Angle End) | | Telephoto End) | |
| \|T_{S1ST} − T_{S3S10}\| | 14.4 | mm | \|T_{S1ST} − T_{S3S10}\| | 14.4 mm | T_{S1ST} − T_{S3S10} | 14.4 mm |
| (The Wide-Angle | | | (The Telephoto | | (The Wide-Angle | |
| End) | | | End) | | End) | |
| T_{S1ST} − T_{S3S10} | 14.4 | mm | T_{S1ST}/T_{STS15} (The | 5.89 | T_{S1ST}/T_{STS15} | 5.13 |
| (The Telephoto | | | Wide-Angle End) | | (The Telephoto | |
| End) | | | | | End) | |
| T7ob (The Wide- | 26.6 | mm | T7ob (The | 29.0 mm | T7ob/f_{LG1} (The | −1.29 |
| Angle End) | | | Telephoto End) | | Wide-Angle End) | |

| | |
|---|---|
| T7ob/f_{LG1} (The | −1.40 |
| Telephoto End) | |

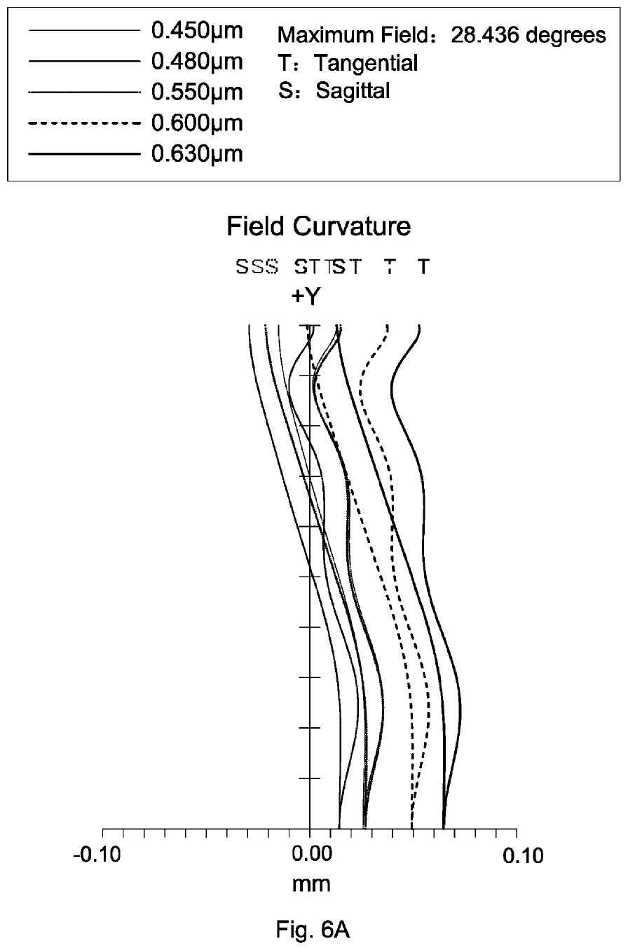

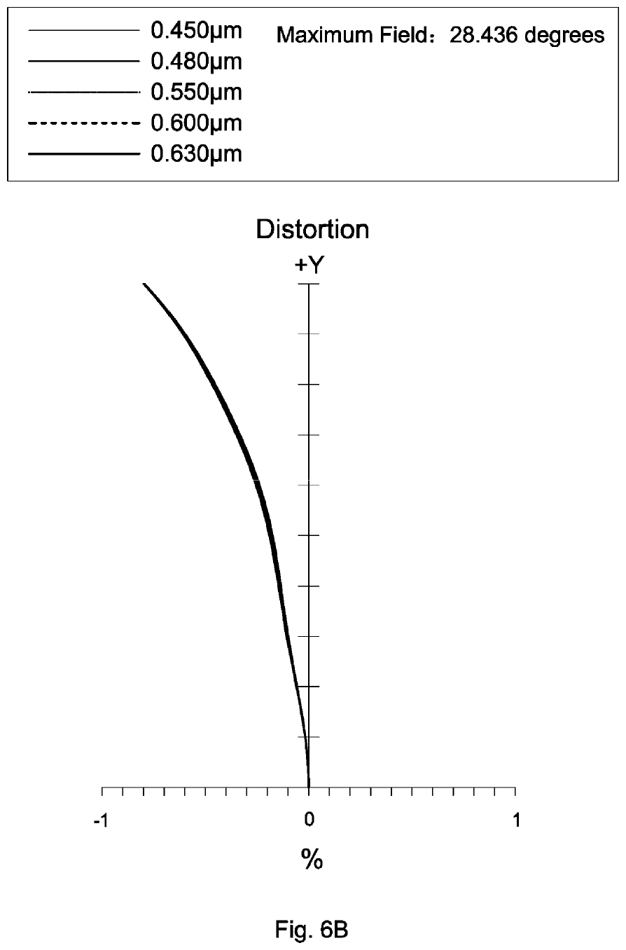

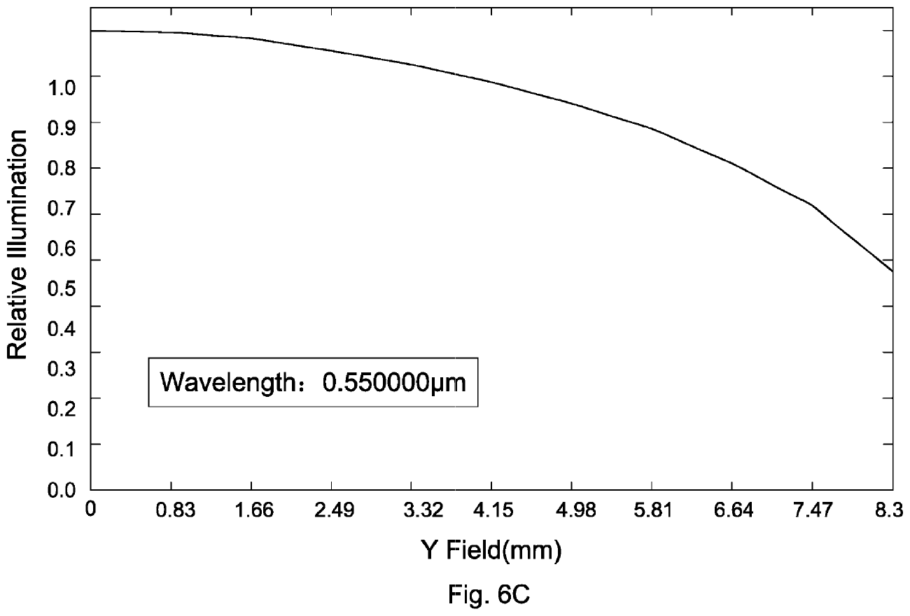

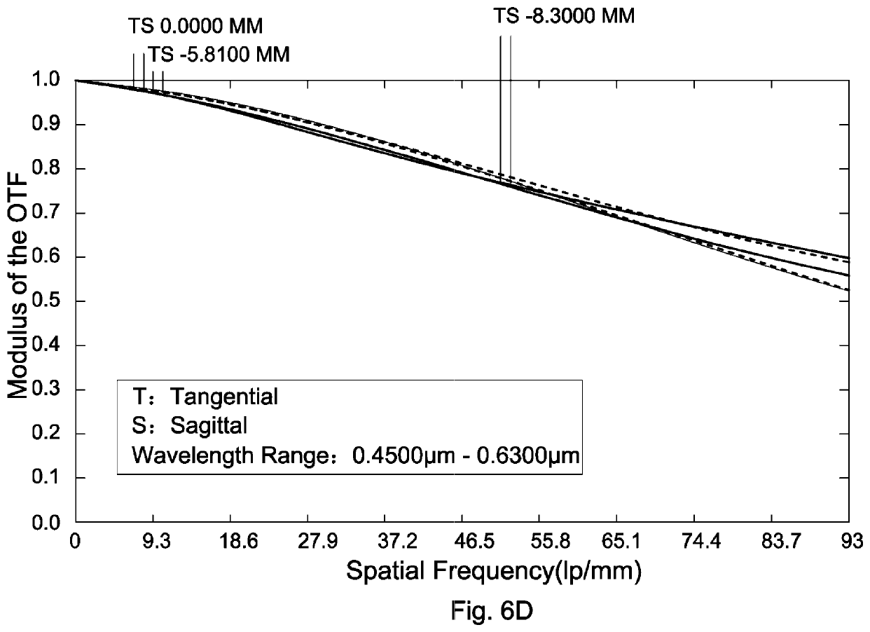

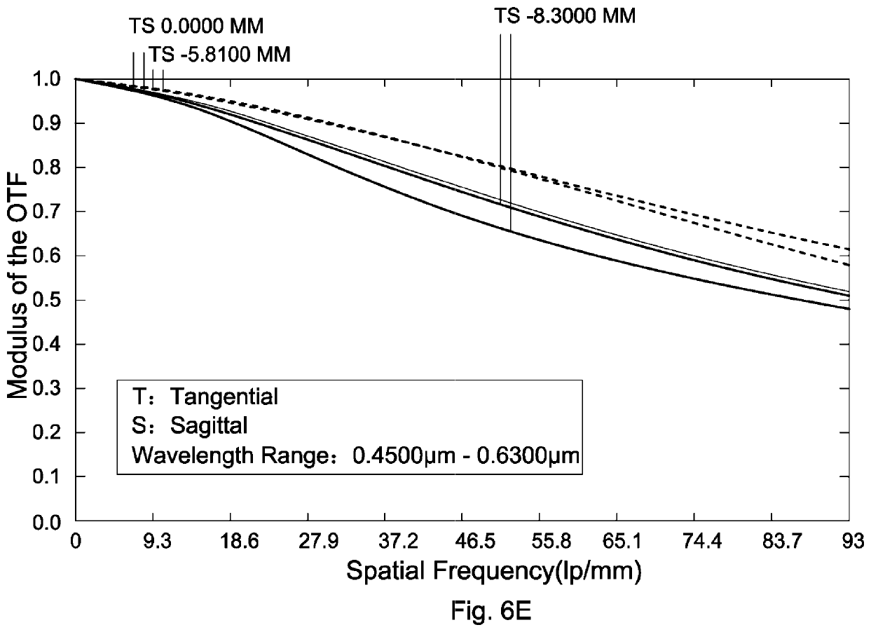

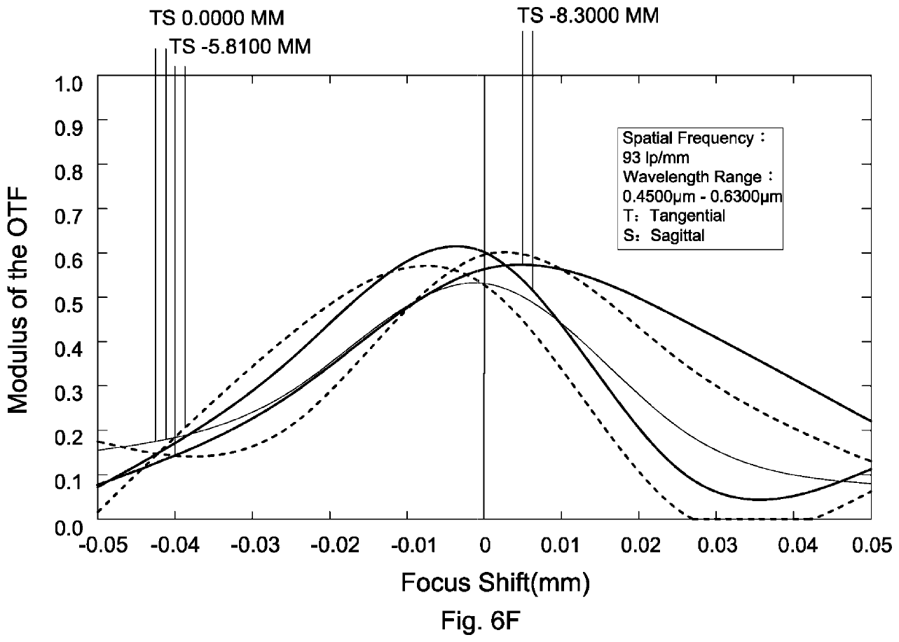

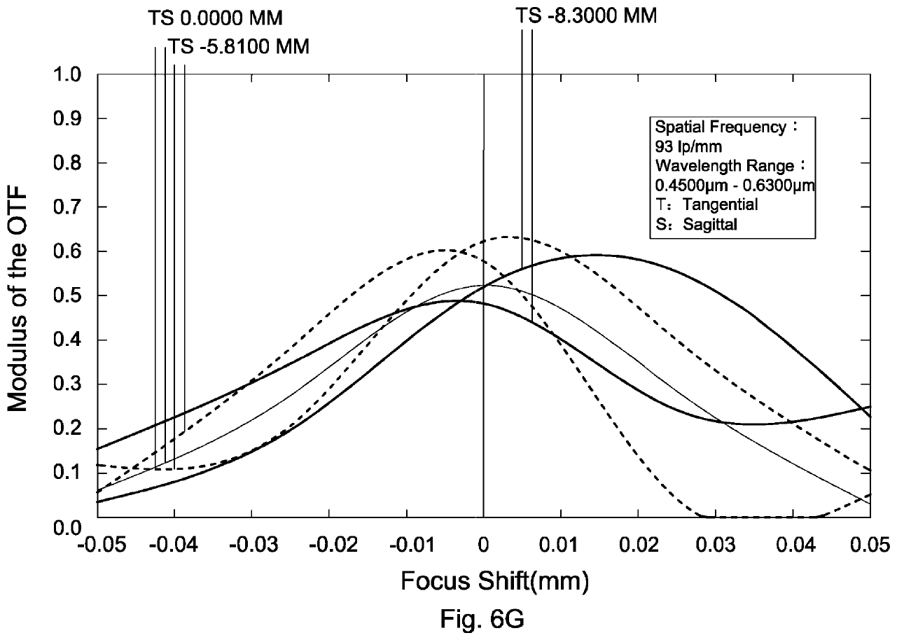

The lens apparatus 3 can also meet the requirements of optical performance as seen in FIGS. 6A-6G. It can be seen from FIG. 6A that a field curvature of the lens apparatus 3 at the wide-angle end ranges from −0.04 mm to 0.08 mm. It can be seen from FIG. 6B that a distortion of the lens apparatus 3 at the wide-angle end ranges from −0.8% to 0%. It can be seen from FIG. 6C that a relative illumination of the lens apparatus 3 at the wide-angle end ranges from 0.48 to 1.0. It can be seen from FIG. 6D that a modulation transfer function of the lens apparatus 3 at the wide-angle end ranges from 0.52 to 1.0. It can be seen from FIG. 6E that a modulation transfer function of the lens apparatus 3 at the telephoto end ranges from 0.48 to 1.0. It can be seen from FIG. 6F that the modulation transfer function of the lens apparatus 3 at the wide-angle end ranges from 0 to 0.62 as a focus shift ranges between −0.05 mm and 0.05 mm. It can be seen from FIG. 6G that the modulation transfer function of the lens apparatus 3 at the telephoto end ranges from 0 to 0.64 as a focus shift ranges between −0.05 mm and 0.05 mm.

It is obvious that the field curvature and the distortion of the lens apparatus 3 can be corrected effectively, and the relative illumination, the resolution and the depth of focus of the lens apparatus 3 can meet the requirements. Therefore, the lens apparatus 3 is capable of good optical performance.

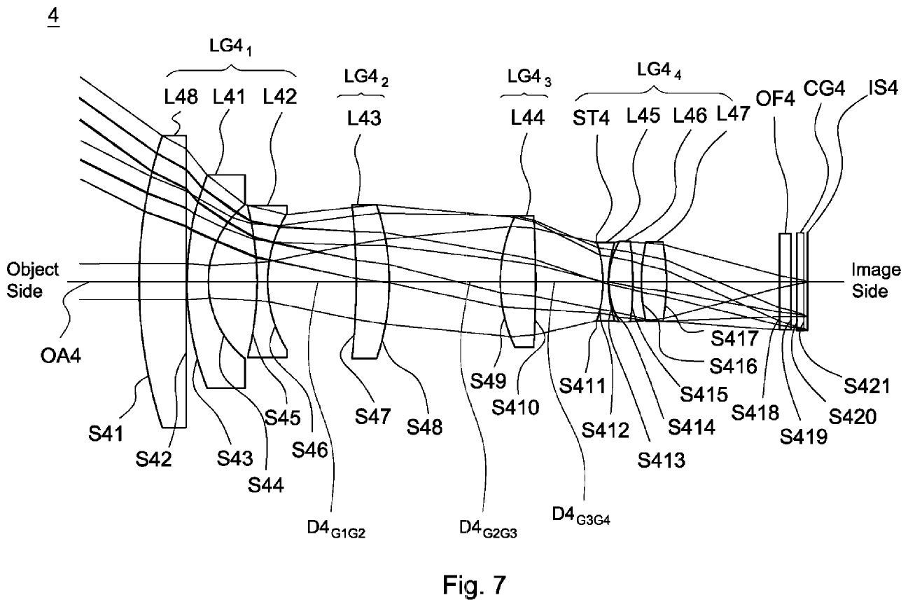

Referring to FIG. 7, FIG. 7 is a lens layout and optical path diagram of a lens apparatus in accordance with a fourth embodiment of the invention. A lens apparatus 4 includes a first lens group LG4₁, a second lens group LG4₂, a third lens group LG4₃, a fourth lens group LG4₄, an optical filter OF4 and a cover glass CG4. The first lens group LG4₁ includes an eighth lens L48, a first lens L41 and a second lens L42. The second lens group LG4₂ includes a third lens L43. The third lens group LG4₃ includes a fourth lens L44. The fourth lens group LG4₄ includes a stop ST4, a fifth lens L45, a sixth lens L46 and a seventh lens L47. The eighth lens L48, the first lens L41, the second lens L42, the third lens L43, the fourth lens L44, the stop ST4, the fifth lens L45, the sixth lens L46 and the seventh lens L47 are arranged in order from an image side to an objective side along an optical axis OA4.

The difference between the fourth embodiment and the first embodiment as shown in FIG. 1 is described herein. The eighth lens L48 can be, for example, a meniscus lens and with positive refractive power. An image side surface S41 of the eighth lens L48 can be, for example, a convex surface, and an objective side surface S42 of the eighth lens L48 can be, for example, a concave surface. The image side surface S41 can be, for example, a spherical surface, and the objective side surface S42 can be, for example, a spherical surface. An image side surface S45 of the second lens L42 can be, for example, a concave surface and a spherical surface, and an objective side surface S46 of the second lens L42 can be, for example, a spherical surface. An objective side surface S415 of the sixth lens L46 can be, for example, a convex surface. In the present of other embodiment, the fifth lens L45, the sixth lens L46 and the seventh lens L47 can, for example, include at least one aspheric surface. The other elements of the lens apparatus 4 of the fourth embodiment as shown in FIG. 7 are similar to those of the lens apparatus 1 as shown in FIG. 1, and therefore the descriptions thereof are omitted.

During operation, light from an object IS4 travels to the image side finally. By changing a distance D4_{G1G2} between the first lens group LG4₁ and the second lens group LG4₂, a distance D4_{G2G3} between the second lens group LG4₂ and the third lens group LG4₃ and a distance D4_{G3G4} between the third lens group LG4₃ and the fourth lens group LG4₄, the effective focal length of the lens apparatus 4 can be adjusted. When the first lens group LG4₁ is moved along the optical axis OA4 to change the distance D4_{G1G2}, the lens apparatus 4 is focusing.

By the design of the above lenses, the stop ST4 and at least one of the conditions (1)-(10) satisfied, the lens apparatus 4 is able to have the lens diameter effectively reduced, brightness and resolution effectively increased, and aberration effectively corrected.

In order to achieve the above purposes and effectively enhance the optical performance, the lens apparatus 4 of the fourth embodiment of the invention is provided with the optical specifications shown in Table 10, which include curvature of each lens surface, distance between adjacent surface, refractive index of each lens, Abbe number of each lens and effective focal length of each lens. Table 10 shows that the lens apparatus 4 at a wide-angle end has the effective focal length equal to 12.0 mm and F-number equal to 1.94, and the lens apparatus 4 at a telephoto end has the effective focal length equal to 14.4 mm and F-number equal to 2.07.

TABLE 10

| | | | | | Effective | |
|---|---|---|---|---|---|---|
| | | | | | Focal | |
| Surface | Curvature | Distance | | | Length | |
| Number | (mm⁻¹) | (mm) | Nd | Vd | (mm) | Remark |
| S41 | 0.01 | 8.0 | 1.58 | 62.00 | 172.414 | The Eighth |
| | | | | | | Lens L48 |
| S42 | 0.0012 | 0.2 | | | | |
| S43 | 0.02 | 3.6 | 1.71 | 64.00 | −38.68 | The First |
| | | | | | | Lens L41 |
| S44 | 0.06 | 8.3 | | | | |
| S45 | −0.02 | 1.8 | 1.65 | 34.00 | −21.542 | The Second |
| | | | | | | Lens L42 |
| S46 | 0.05 | 15.0 | | | | The |
| | | (The Wide- | | | | Distance |
| | | Angle End) | | | | D4_{G1G2} |
| | | 13.1 | | | | |
| | | (The | | | | |
| | | Telephoto | | | | |
| | | End) | | | | |
| S47 | −0.01 | 5.6 | 1.80 | 27.00 | 113.682 | The Third |
| | | | | | | Lens L43 |
| S48 | −0.02 | 18.8 | | | | The |
| | | (The Wide- | | | | Distance |
| | | Angle End) | | | | D4_{G2G3} |
| | | 11.4 | | | | |
| | | (The | | | | |
| | | Telephoto | | | | |
| | | End) | | | | |
| S49 | 0.04 | 6.0 | 1.72 | 52.00 | 28.941 | The Fourth |
| | | | | | | Lens L44 |
| S410 | −0.01 | 10.4 | | | | The |
| | | (The Wide- | | | | Distance |
| | | Angle End) | | | | D4_{G3G4} |
| | | 11.7 | | | | |
| | | (The | | | | |
| | | Telephoto | | | | |
| | | End) | | | | |
| S411 | 0.00 | 1.0 | | | | The Stop |
| | | | | | | ST4 |
| S412 | −0.04 | 1.0 | 1.74 | 28.00 | −33.784 | The Fifth |
| | | | | | | Lens L45 |
| S413 | 0.05 | 0.1 | | | | |
| S414 | 0.07 | 4.0 | 1.50 | 81.00 | 25.597 | The Sixth |
| | | | | | | Lens L46 |
| S415 | −0.01 | 1.6 | | | | |
| S416 | 0.03 | 4.2 | 1.60 | 60.00 | 29.155 | The Seventh |
| | | | | | | Lens L47 |
| S417 | −0.03 | 19.2 | | | | |
| | | (The Wide- | | | | |
| | | Angle End) | | | | |
| | | 21.4 | | | | |
| | | (The | | | | |
| | | Telephoto | | | | |
| | | End) | | | | |
| S418 | 0.00 | 2.0 | 1.52 | 58.00 | | The Optical |
| | | | | | | Filter OF4 |
| S419 | 0.00 | 1.0 | | | | |
| S420 | 0.00 | 1.1 | 1.51 | 62.00 | | Cover Glass |
| | | | | | | CG4 |
| S421 | 0.00 | 0.7 | | | | |

Table 11 shows the optical specifications of the lens apparatus 4 and calculated values corresponding to the conditions (1)-(10). It can be seen from Table 11 that the lens apparatus 4 can meet requirements of the conditions (1)-(10).

TABLE 11

| | | | | | |
|---|---|---|---|---|---|
| f_{LG1} | −15.9 mm | TTL (The Wide- | 89.6 mm | TTL (The | 81.6 mm |
| | | Angle End) | | Telephoto End) | |
| T_{S1ST} (The Wide- | 77.7 mm | T_{S1ST} (The | 69.7 mm | T_{S3S10} (The Wide- | 58.6 mm |
| Angle End) | | Telephoto End) | | Angle End) | |
| T_{S3S10} (The | 50.6 mm | T_{STS15} (The Wide- | 11.9 mm | T_{STS15} (The | 23.6 mm |
| Telephoto End) | | Angle End) | | Telephoto End) | |
| f_{LG1}/f (The | −1.33 | f_{LG1}/f (The | −1.10 | Vd₆/Vd₃ | 3 |
| Wide-Angle End) | | Telephoto End) | | | |
| \|f₁ + f₃\| | 75.00 mm | f₁ + f₃ | 75.00 mm | f₃/f (The Wide- | 9.47 |
| | | | | Angle End) | |
| f₃/f (The | 7.89 | TTL/f_{LG1} (The | −5.64 | TTL/f_{LG1} (The | −5.13 |
| Telephoto End) | | Wide-Angle End) | | Telephoto End) | |
| \|T_{S1ST} − T_{S3S10}\| | 19.1 mm | \|T_{S1ST} − T_{S3S10}\| | 19.1 mm | T_{S1ST} − T_{S3S10} | 19.1 mm |
| (The Wide- | | (The Telephoto | | (The Wide-Angle | |
| Angle End) | | End) | | End) | |
| T_{S1ST} − T_{S3S10} | 19.1 mm | T_{S1ST}/T_{STS15} | 6.53 | T_{S1ST}/T_{STS15} | 2.95 |
| (The Telephoto | | (The Wide-Angle | | (The Telephoto | |
| End) | | End) | | End) | |
| T7ob (The Wide- | 24.0 mm | T7ob (The | 26.2 mm | T7ob/f_{LG1} (The | −1.50 |
| Angle End) | | Telephoto End) | | Wide-Angle End) | |
| T7ob/f_{LG1} (The | −1.64 | | | | |
| Telephoto End) | | | | | |

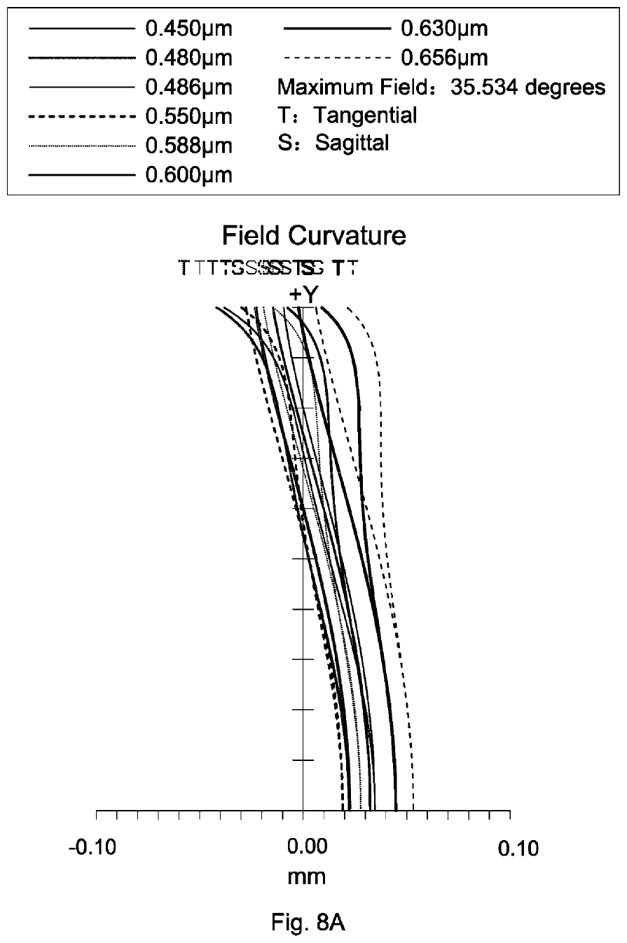

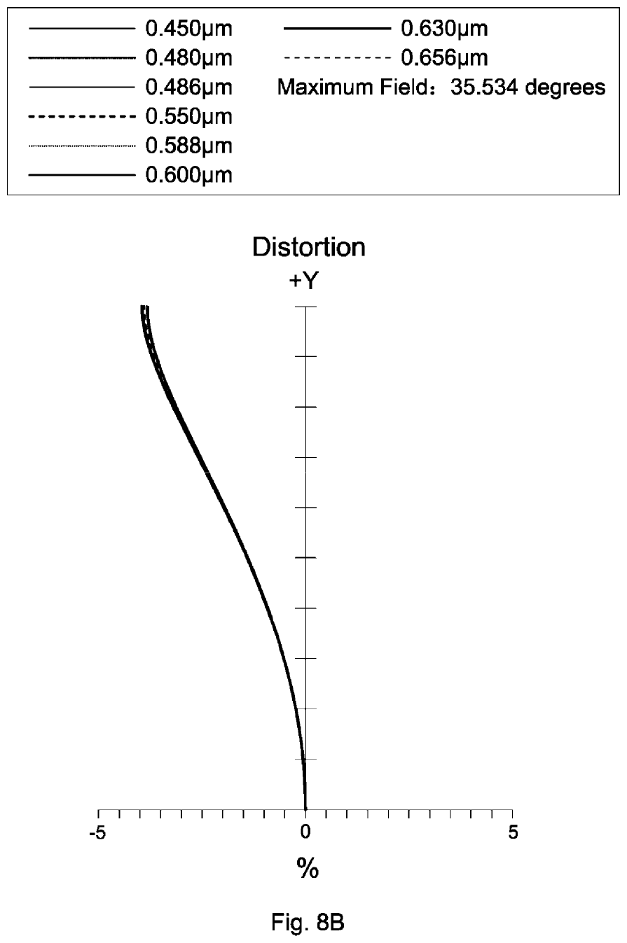

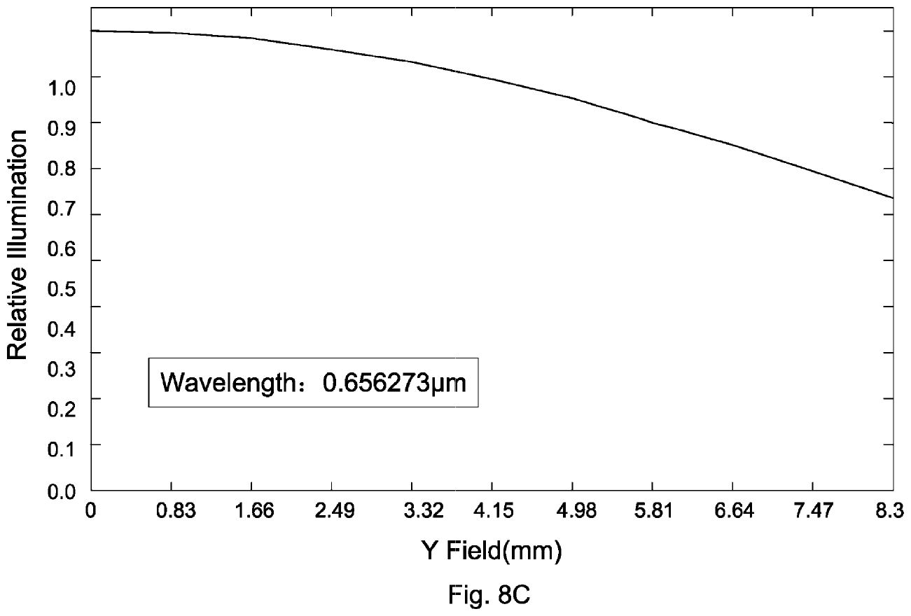

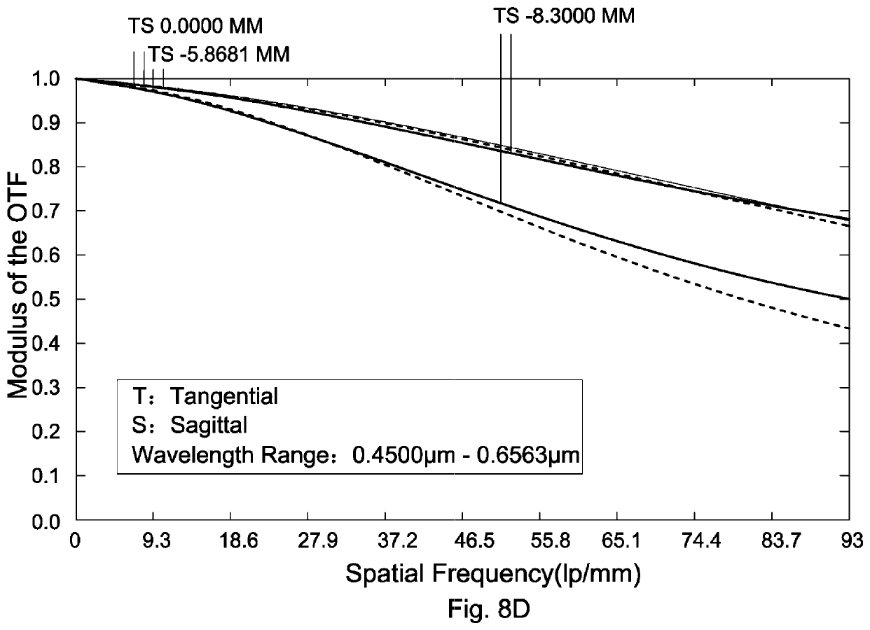

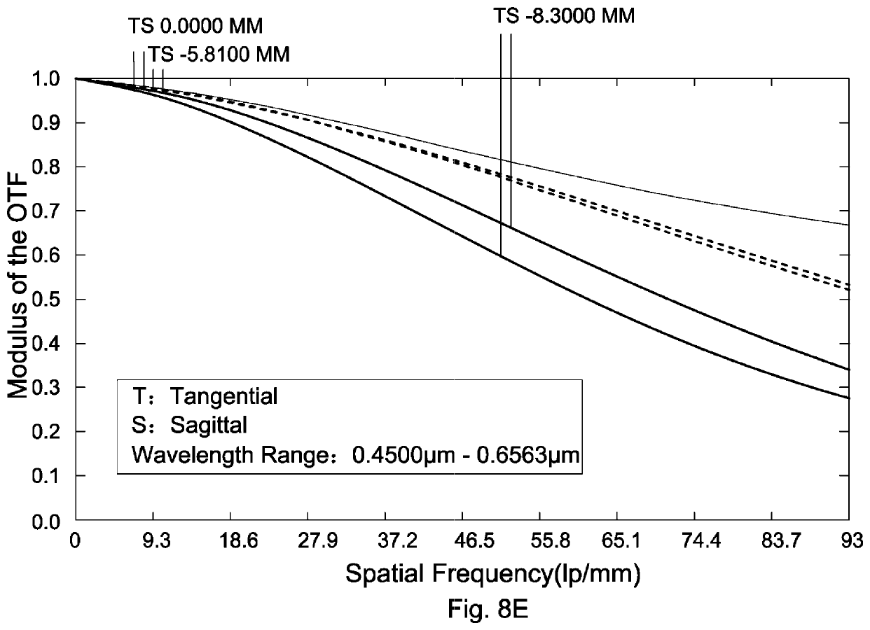

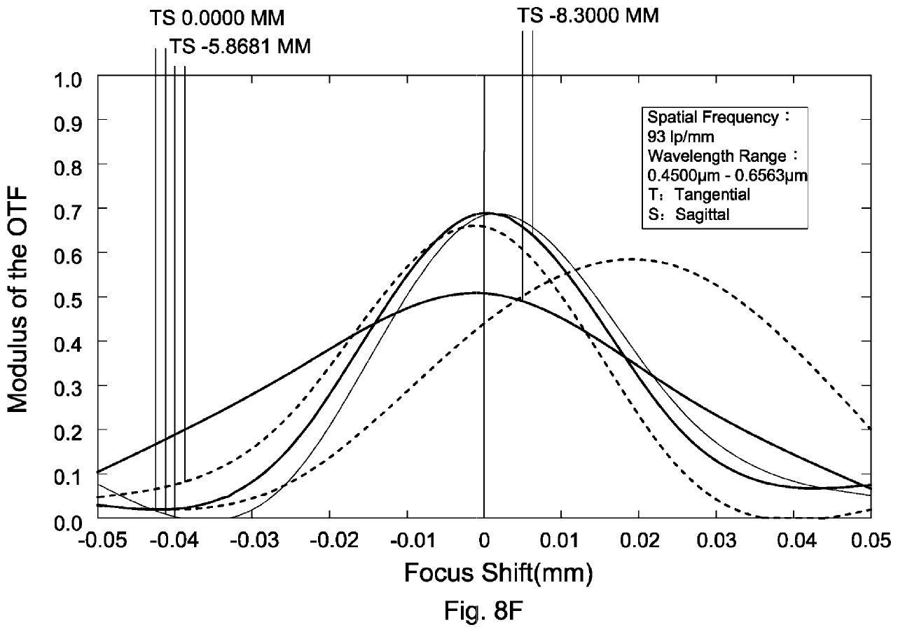

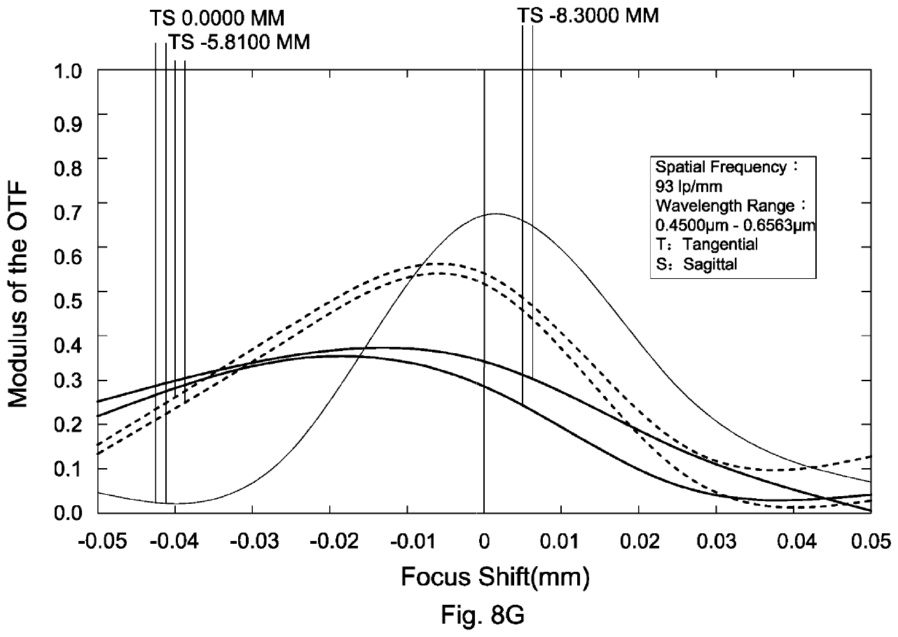

The lens apparatus 4 can also meet the requirements of optical performance as seen in FIGS. 8A-8G. It can be seen from FIG. 8A that a field curvature of the lens apparatus 4 at the wide-angle end ranges from −0.05 mm to 0.06 mm. It can be seen from FIG. 8B that a distortion of the lens apparatus 4 at the wide-angle end ranges from −4% to 0%. It can be seen from FIG. 8C that a relative illumination of the lens apparatus 4 at the wide-angle end ranges from 0.64 to 1.0. It can be seen from FIG. 8D that a modulation transfer function of the lens apparatus 4 at the wide-angle end ranges from 0.43 to 1.0. It can be seen from FIG. 8E that a modulation transfer function of the lens apparatus 4 at the telephoto end ranges from 0.28 to 1.0. It can be seen from FIG. 8F that the modulation transfer function of the lens apparatus 4 at the wide-angle end ranges from 0 to 0.69 as a focus shift ranges between −0.05 mm and 0.05 mm. It can be seen from FIG. 8G that the modulation transfer function of the lens apparatus 4 at the telephoto end ranges from 0 to 0.68 as a focus shift ranges between −0.05 mm and 0.05 mm.

It is obvious that the field curvature and the distortion of the lens apparatus 4 can be corrected effectively, and the relative illumination, the resolution and the depth of focus of the lens apparatus 4 can meet the requirements. Therefore, the lens apparatus 4 is capable of good optical performance.

Although the objective side surface S42 of the eighth lens L48 of the above-described lens apparatus 4 is a concave surface, the invention is not limited thereto. That is to say, the objective side surface of the eighth lens can be adjusted according to the requirement of actual application. In other embodiments of the invention, the objective side surface of the eighth lens can be designed as a flat surface. If it is desired to improve the wide-angle performance of the lens apparatus, the value of the curvature of the objective side surface of the eighth lens can be increased. If it is desired to improve the telephoto performance of the lens apparatus, the effective focal length of the lens apparatus can be slightly increased and the objective side surface of the eighth lens can be designed as a convex surface.

What is claimed is:

1. A lens apparatus comprising:
a first lens group comprising a first lens with negative refractive power and a second lens with negative refractive power, wherein the first lens comprises a convex surface facing an image side and a concave surface facing an objective side;
a second lens group comprising a third lens with positive refractive power;
a third lens group comprising a fourth lens with positive refractive power; and
a fourth lens group comprising a fifth lens with negative refractive power, a sixth lens with positive refractive power and a seventh lens with positive refractive power, wherein the seventh lens comprises a convex surface facing the image side;
wherein the first lens, the second lens, the third lens, the fourth lens, the fifth lens, the sixth lens and the seventh lens are arranged in order from the image side to the objective side along an optical axis;
wherein the lens apparatus satisfies:
−2.28<f_{LG1}/f<−0.59,
where f is an effective focal length of the lens apparatus, and f_{LG1} is an effective focal length of the first lens group.

2. The lens apparatus as claimed in claim 1, wherein:
the second lens comprises a concave surface facing the objective side;
the fourth lens comprises a convex surface facing the image side;
the fifth lens comprises a concave surface facing the image side;
the sixth lens comprises a convex surface facing the image side; and
the seventh lens comprises a convex surface facing the objective side.

3. The lens apparatus as claimed in claim 1, wherein:
the second lens comprises a convex surface or a concave surface facing the image side;
the third lens comprises a convex surface or a concave surface facing the image side;
the fourth lens comprises a convex surface or a flat surface facing the objective side;
the fifth lens comprises a concave surface or a flat surface facing the objective side; and
the sixth lens comprises a convex surface or a flat surface facing the objective side.

4. The lens apparatus as claimed in claim 1, wherein the first lens group is with negative refractive power and the fourth lens group is with positive refractive power.

5. The lens apparatus as claimed in claim 4, wherein:
the second lens comprises a convex surface or a concave surface facing the image side;
the third lens comprises a convex surface or a concave surface facing the image side;
the fourth lens comprises a convex surface or a flat surface facing the objective side;
the fifth lens comprises a concave surface or a flat surface facing the objective side; and
the sixth lens comprises a convex surface or a flat surface facing the objective side.

6. The lens apparatus as claimed in claim 4, wherein the first lens group further comprises an eighth lens disposed between the image side and the first lens, and the eighth lens is with positive refractive power and comprises a convex surface facing the image side and a concave surface facing the objective side.

7. The lens apparatus as claimed in claim 4, wherein the second lens group is with positive refractive power, and the third lens group is with positive refractive power.

8. The lens apparatus as claimed in claim 7, wherein:
the second lens comprises a concave surface facing the objective side, and comprises a convex surface or another concave surface facing the image side;
the third lens comprises a convex surface or a concave surface facing the image side;
the fourth lens comprises a convex surface facing the image side, and comprises another convex surface or a flat surface facing the objective side;
the fifth lens comprises a concave surface facing the image side, and comprises another concave surface or a flat surface facing the objective side;
the sixth lens comprises a convex surface facing the image side, and comprises another convex surface or a flat surface facing the objective side; and
the seventh lens comprises a convex surface facing the objective side.

9. The lens apparatus as claimed in claim 8, wherein the first lens group further comprises an eighth lens disposed between the image side and the first lens, and the eighth lens is with positive refractive power and comprises a convex surface facing the image side and a concave surface facing the objective side.

10. The lens apparatus as claimed in claim 7, wherein the lens apparatus satisfies:
−9.6≤TTL/f_{LG1}≤−5.19,
29 mm<|f₁+f₃<90 mm, or
1.77<f₃/f<12
where f_{LG1} is the effective focal length of the first lens group, TTL is a distance between an image side surface of a lens closest to the image side and an objective side surface of the seventh lens along the optical axis, f is the effective focal length of the lens apparatus, f₃ is a focal length of the third lens, and f₁ is a focal length of the first lens.

11. The lens apparatus as claimed in claim 10, wherein the lens apparatus satisfies:
2≤Vd₆/Vd₃≤4,
8.16 mm<|T_{S1ST}−T_{S3S10}<22.92 mm,
5.22<T_{S1ST}/T_{STS15}<8.23, or
−2.54<T7ob/f_{LG1}<−1.3
where Vd₃ is an Abbe number of the third lens, Vd₆ is an Abbe number of the sixth lens, T_{S1ST} is a distance between an image side surface of a lens closest to the image side and the stop along the optical axis, T_{S3S10} is a distance between an image side surface of the second lens and an image side surface of the fifth lens along the optical axis, T_{STS15} is a distance between the stop and an objective side surface of the seventh lens along the optical axis, f_{LG1} is the effective focal length of the first lens group, and T7ob is a distance between an objective side surface of the seventh lens and an object along the optical axis.

12. The lens apparatus as claimed in claim 7, wherein at least one of the first lens group, the second lens group, the third lens group and the fourth lens group is movable along the optical axis, the fifth lens and the sixth lens are cemented together, and the lens apparatus is a projection lens.

13. The lens apparatus as claimed in claim 4, wherein the lens apparatus satisfies:
2≤Vd₆/Vd₃≤4,
where Vd₃ is an Abbe number of the third lens, and Vd₆ is an Abbe number of the sixth lens.

14. The lens apparatus as claimed in claim 4, wherein the lens apparatus satisfies:
29 mm<|f₁+f₃<90 mm; and
1.77<f₃/f<12,
where f is the effective focal length of the lens apparatus, f₃ is a focal length of the third lens, and f₁ is a focal length of the first lens.

15. The lens apparatus as claimed in claim 4, wherein the lens apparatus satisfies:
−9.6≤TTL/f_{LG1}≤−5.19,
where f_{LG1} is the effective focal length of the first lens group, and TTL is a distance between an image side surface of a lens closest to the image side and an objective side surface of the seventh lens along the optical axis.

16. The lens apparatus as claimed in claim 4, wherein the fourth lens group further comprises a stop disposed between the fourth lens and the fifth lens, and the lens apparatus satisfies:
8.16 mm<|T_{S1ST}−T_{S3S10}<22.92 mm, or 5.22<T_{S1ST}/T_{STS15}<8.23,
where T_{S1ST} is a distance between an image side surface of a lens closest to the image side and the stop along the optical axis, T_{S3S10} is a distance between an image side surface of the second lens and an image side surface of the fifth lens along the optical axis, and T_{STS15} is a distance between the stop and an objective side surface of the seventh lens along the optical axis.

17. The lens apparatus as claimed in claim 4, wherein the lens apparatus satisfies:
−2.54<T7ob/f_{LG1}<−1.3,
where f_{LG1} is the effective focal length of the first lens group, and T7ob is a distance between an objective side surface of the seventh lens and an object along the optical axis.

18. The lens apparatus as claimed in claim 4, wherein at least one of the first lens group, the second lens group, the third lens group and the fourth lens group is movable along the optical axis, the fifth lens and the sixth lens are cemented together, and the lens apparatus is a projection lens.

19. The lens apparatus as claimed in claim 1, wherein the lens apparatus satisfies:
−9.6≤TTL/f_{LG}1b≤−5.19,
where f_{LG1} is the effective focal length of the first lens group, and TTL is a distance between an image side surface of a lens closest to the image side and an objective side surface of the seventh lens along the optical axis.
